(19) United States
(12) Patent Application Publication
(10) Pub. No.: US 2026/0330191 A1
(43) Pub. Date: Oct. 22, 2026

(54) SYSTEM

(71) Applicant: SoftBank Group Corp., Tokyo (JP)

(72) Inventor: Kazufumi OMAKI, Tokyo (JP)

(73) Assignee: SoftBank Group Corp., Tokyo (JP)

(21) Appl. No.: 19/650,347

(22) Filed: Apr. 17, 2026

(30) Foreign Application Priority Data
Apr. 22, 2025 (JP) 2025-070646

(51) Int. Cl. G06N 3/0464; G06N 5/022

(52) U.S. Cl. CPC G06N 3/0464; G06N 5/022

(57) ABSTRACT

The present invention relates to an internal knowledge base system that supports business issue resolution of an employee using generative AI, and is a system configured such that an issue input unit performs issue reception and information complementation in a natural language, a case search unit searches a past case based on keyword extraction and an employee attribute, a solution presentation unit automatically generates a specific solution and an implementation procedure according to a situation, an execution support unit automates task breakdown and progress management, an effect measurement unit evaluates a quantitative and qualitative effect, and a continuous improvement unit analyzes a company-wide tendency and risk to generate a business improvement proposal, thereby realizing aggregation of know-how distributed in a personalized manner, efficiency improvement of information search, and continuous evolution of organizational knowledge.

### CROSS-REFERENCE TO RELATED APPLICATION

The present application claims priority to and incorporates by reference the entire contents of Japanese Patent Application No. 2025-070646 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is to comprehensively resolve wide-ranging factors inhibiting business efficiency, knowledge sharing, and organizational strength enhancement, such as: the difficulty in quickly and accurately searching and utilizing necessary information because, when an employee faces a business issue within a corporate group, past cases of solving similar issues and know-how are accumulated in a distributed and personalized manner in each department or individual; the resulting inefficiency that a great deal of time and effort is required to resolve the issue and similar problems occur repeatedly; the stagnation of knowledge distribution where the knowledge of the entire organization is not sufficiently shared and utilized; the loss of organizational learning opportunities due to past cases and know-how being buried without being turned into explicit knowledge; the variation in business quality due to the effort of information search and dependence on personalized responses; and the delay in risk management and business improvement as the entire organization, and to dramatically improve the productivity and competitiveness of the entire corporate group by enabling each employee to quickly and accurately resolve their own issue and realizing continuous business improvement and risk prevention by aggregating, analyzing, and utilizing the knowledge of the entire organization.

### SUMMARY OF THE INVENTION

The present invention solves the issue by providing a system comprising an issue input unit, a case search unit, a solution presentation unit, an execution support unit, an effect measurement unit, and a continuous improvement unit, wherein each unit operates using generative AI. That is, the issue input unit receives business issue information input in a natural language from an employee, and the case search unit extracts a related keyword from the issue information using the generative AI, searches an internal case database in combination with attribute information of the employee, and extracts a corresponding past case. The solution presentation unit presents a specific solution and an implementation procedure according to a situation of the employee using the generative AI based on contents of the extracted past case, and guides contact information to a related department or a person in charge as necessary. The execution support unit automatically generates a task necessary for executing the presented solution using the generative AI, registers the task in cooperation with a task management tool, and supports progress management. The effect measurement unit collects an execution result of the task and feedback from the employee, and measures a quantitative and qualitative effect. The continuous improvement unit analyzes information obtained by the effect measurement unit using the generative AI to update a knowledge base, extracts an issue tendency and a potential risk of an entire organization, and reports to a management layer or a management department. With these configurations, know-how and cases accumulated in a personalized manner can be shared and utilized in the entire organization, and the issue resolution capability of each employee and the productivity improvement of the organization can be realized.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

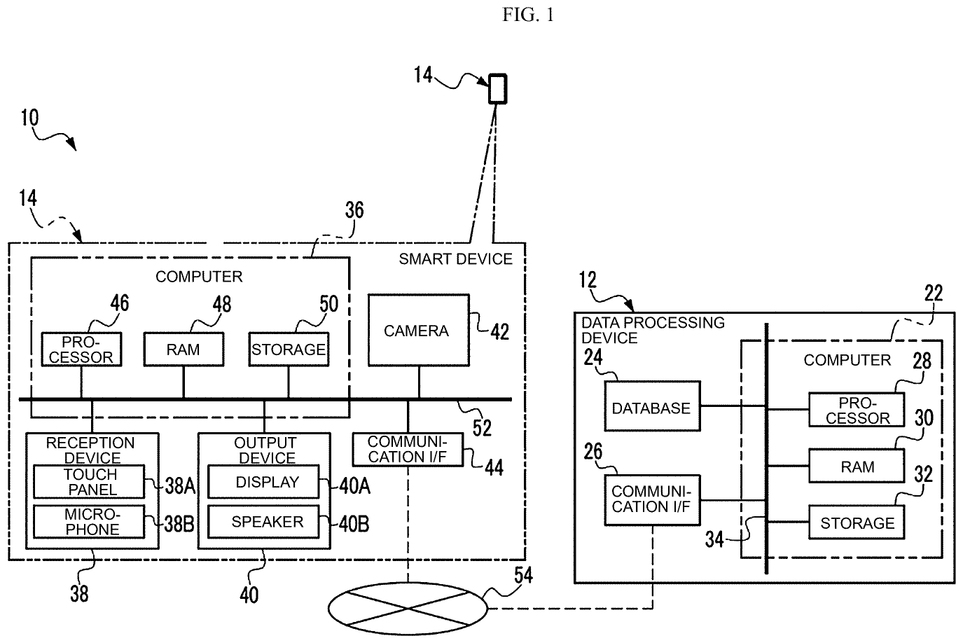

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

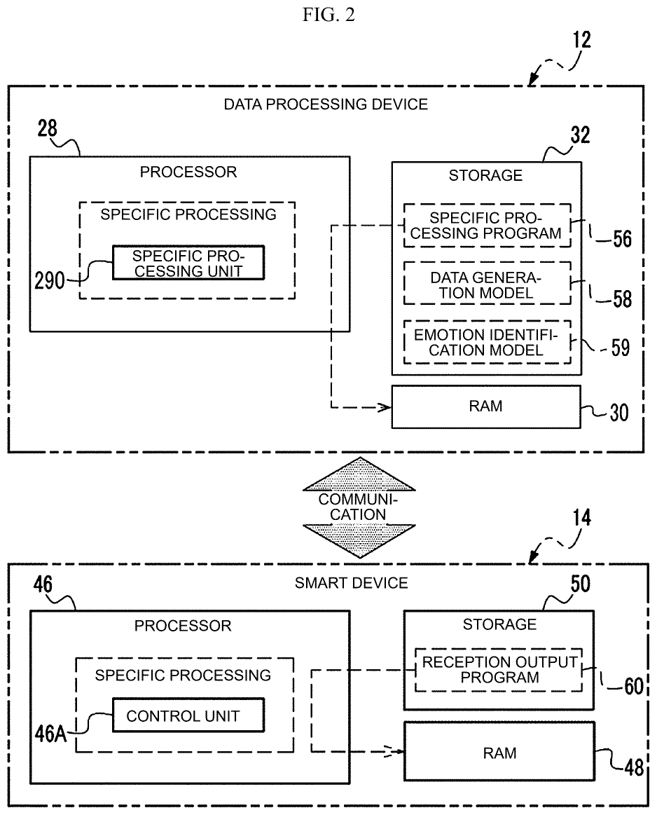

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

Embodiments of the present invention will be described more specifically and in detail.

The system of the present invention is composed of a server and a terminal, aggregates main processing functions such as an execution environment of generative AI, a case database, a task management system, an effect measurement module, and an analysis/report generation function on the server side, and includes a user interface, an input assistance function, a notification reception function, a progress input function, and the like for an employee to use on the terminal side. The terminal is composed of various devices such as a personal computer, a tablet terminal, and a smartphone, and the server is composed of a cloud environment or an on-premises high-performance computer group. Specifically, the system adopts a distributed computing architecture. The system arranges a parallel computing cluster using a GPU on the server side. The parallel computing cluster executes a large-scale language model with a scale of hundreds of billions of parameters at high speed. The system transmits and receives data between the terminal side and the server side using a secure communication protocol. The system executes lightweight edge processing on the terminal side. The edge processing performs initial verification and format conversion of input data. The system offloads heavy inference processing to the server side. This configuration realizes advanced AI processing without depending on computing resources of the terminal. The system adopts a distributed NoSQL database as the case database. The database integrally manages unstructured data and structured data. The system adopts a microservice architecture as the task management system. The architecture deploys each function as an independent container. The system dynamically allocates resources according to a load using a container orchestration tool. The system uses a stream data processing platform in the effect measurement module. The processing platform aggregates data in real time. The system cooperates with a data warehouse in the analysis/report generation function. The cooperation analyzes a huge amount of past history data at high speed. The system dramatically improves a processing speed by these hardware and software configurations. The system significantly reduces a communication load. The system provides a smooth user experience without delay even in a large-scale organization. The system is widely applied to business efficiency improvement and knowledge management fields of companies.

First, an issue input unit is implemented on the terminal side, and provides an interface for the employee to input a business issue in a natural language. For example, a text input field, a voice input function, a chatbot-format interactive UI, and the like are provided, and the employee can input a specific issue faced on site as it is, such as “issuance of an invoice is delayed”, “a contract procedure with a new business partner is complicated”, “an internal approval flow is complex and takes time”, “it takes time to create sales materials every time”, and “a procurement application for IT equipment is delayed”. In the case of voice input, voice recognition is performed on the terminal side, and textified contents are transmitted to the server. In the case of the chatbot format, the employee can also input the issue step by step in accordance with guidance such as “Please tell me what you are having trouble with”. Specifically, the issue input unit implements an edge AI model on the terminal side. The edge AI model executes real-time acoustic feature amount extraction for the voice input. The system acquires voice waveform data as a one-dimensional tensor. The system converts the acquired tensor into a multidimensional vector such as a mel-frequency cepstrum coefficient. The system inputs the converted vector to a recurrent neural network or a transformer-based acoustic model. The acoustic model outputs a probability distribution of phonemes from the input vector. The system decodes a phoneme sequence into a text character string using a language model. The system executes preprocessing of natural language processing for text input. The preprocessing divides an input character string into subword units. The system converts the divided tokens into an array of integer IDs. The system implements a state transition machine in the chatbot-format interactive UI. The state transition machine holds an input history of a user as a session state. The system dynamically determines guidance to be presented next based on the session state. The system removes noise and unnecessary symbols from the input data. The system transmits normalized text data to the server. The system completes these preprocessings on the terminal side. This configuration reduces a calculation load on the server side. The system suppresses consumption of a network bandwidth. The system accurately digitizes an input intention of the user. The system dramatically improves efficiency of input work in use cases such as help desk business and internal inquiry response.

The input issue information is transmitted from the terminal to the server. On the server side, the generative AI receives issue input contents, and performs keyword extraction, intention analysis, and context understanding using a natural language processing technology. For example, keywords such as “invoice”, “issuance”, “delay”, “accounting department”, and “end of month” are extracted to grasp a gist and a background of the issue. When the input contents are ambiguous or information is missing, the generative AI automatically generates an additional question through the interface on the terminal side, and asks the employee for supplementary information such as “which business partner's invoice is it?”, “what is the frequency of the issuance delay?”, and “in which business process is a bottleneck occurring?”. For example, when the employee inputs “creation of a contract is delayed”, the generative AI interactively collects information necessary for specifying the issue, such as “is it a new contract or a renewal contract?”, “what is the type of the contract?”, and “which department is involved?”. Specifically, the server inputs the received text data to a large-scale language model. The large-scale language model includes a multi-layer self-attention mechanism. The system converts the text data into a high-dimensional embedding vector. The system generates, for example, a 768-dimensional dense vector. The system supplies the embedding vector to an input layer of the large-scale language model. The large-scale language model executes a weighting operation according to a context for the input vector. The large-scale language model outputs an intention classification label and an extracted entity vector. The system specifies a specific keyword from the output entity vector. The system extracts a named entity such as a department name and a business name, for example. The system evaluates completeness of the extracted information group. The system calculates information entropy. The system determines that information is missing when the information entropy exceeds a preset threshold. The system activates an additional question generation module when determining that information is missing. The module specifies a type of a missing entity. The module dynamically constructs a prompt based on the specified type. The module re-inputs the constructed prompt to the large-scale language model. The large-scale language model generates a text character string of the additional question. The system evaluates a probability distribution of the generated text character string. The system selects a character string with the highest probability. The system transmits the selected character string to the terminal. The system repeats this interactive process until receiving an answer from the user. The system automates advanced hearing on behalf of a human operator. The system dramatically improves accuracy of requirement definition. The system is applied to an initial response of business consulting and internal IT support.

Next, the case search unit is implemented on the server side, and searches the internal case database based on the keyword extracted by the generative AI and the attribute information of the employee (affiliation department, job title, work location, assigned business, years of experience, past issue resolution history, etc.). In the case database, contents of an issue that occurred in the past, a solution, an implementation procedure, a person in charge, an occurrence department, an occurrence time, a period until resolution, an obtained effect, a related document and template, an FAQ, a reference material, external vendor information, a business flow chart, a checklist, an internal regulation, and the like are systematically recorded. The generative AI performs not only simple keyword matching but also semantic similarity calculation, attribute matching, time-series analysis, business process similarity evaluation, past feedback evaluation, and the like, and preferentially extracts a case closest to a situation of the employee. For example, a plurality of specific past cases can be presented, such as “a person in charge in the accounting department resolved a delay in invoice issuance by introducing an automation tool”, “the sales department shortened a procedure time by digitizing a new business partner contract”, and “the IT department streamlined an approval process by digitizing a procurement application”. Specifically, the case search unit constructs a vector database. The system inputs internal past case data to a transformer encoder in advance. The encoder converts each case text into, for example, a 1024-dimensional case vector. The system indexes and stores the generated case vector in the vector database. The system combines the issue input contents and the attribute information of the employee at the time of search. The system inputs the combined data to the encoder as a prompt. The encoder generates a search query vector from the input data. The system calculates a cosine similarity between the search query vector and each case vector in the database. The system executes an approximate nearest neighbor search algorithm. The algorithm extracts top dozens of cases with high similarity from millions of case data in milliseconds. The system executes a re-ranking process using a cross-encoder for the extracted candidate group. The re-ranking process receives a pair of the query and the case as an input at the same time. The process outputs a more precise relevance score. The system evaluates freshness of the case using time-series data analysis. The system attenuates a score of an old case. The system multiplies the score by a past feedback evaluation as a weighting coefficient. The system determines a case list of top N cases based on a final comprehensive score. The system realizes a meaning-based search that does not depend on simple character string matching. The system absorbs orthographical variants and differences in synonyms. The system dramatically improves search accuracy. The system is widely applied as a search engine of a knowledge management system or an internal portal site.

The solution presentation unit is implemented on the server side, and automatically generates a specific solution and an implementation procedure according to the situation of the employee using the generative AI based on contents of the extracted past case. For example, practical and detailed advice is presented, such as “when introducing an automation tool for invoice issuance, it is recommended to follow a procedure of inventorying a current business flow, selecting a tool vendor, obtaining internal approval, test operation, production introduction, manual creation, employee education, and effect measurement after operation” and “when digitizing a new business partner contract, it is necessary to set up cooperation with an electronic signature service (registered trademark), revise internal regulations, hold a briefing session for employees, create a guidance document for business partners, and create an operation guideline for electronic contracts”. In addition, as necessary, contact information to an implementation person in charge of the corresponding case or a related department is also automatically guided so that the employee can directly receive advice. For example, specific contact information is presented, such as “the person in charge of this case is Tanaka in the management department, and the extension number is 1234”, “the related department is the information system department, and the inquiry form is here”, and “the contact information of a project leader who resolved a similar issue in the past can be searched on the internal SNS”. Specifically, the solution presentation unit adopts an autoregressive text generation model. The system combines the text data of the extracted past case and a current context vector of the employee. The system supplies the combined data to a decoder of the generation model as an input token sequence. The generation model analyzes a context of the input token sequence. The generation model calculates a probability distribution of a word to appear next. The system executes a beam search algorithm. The algorithm searches for an optimal text sequence while simultaneously holding a plurality of generation candidate sequences. The system applies a constrained decoding method for suppressing hallucination in a generation process. The method collates with an internal regulation database or a contact directory in real time. The system verifies whether a department name or an extension number included in the generated text actually exists. The system discards a generation candidate that has failed the verification. The system adopts only a text that has succeeded in the verification as an output. The system converts the generated solution text into structured data. The system adds metadata such as a step number of a procedure or a name of a person in charge, for example. The system transmits the structured data to the user interface. The system instantly generates logical and accurate advice as if created by a human expert. The system eliminates dependence on personalized know-how. The system brings about standardization and quality improvement of a business process. The system is applied to automatic generation of a business manual or an automatic response system of an internal help desk.

Furthermore, the solution presentation unit can also compare and present a plurality of solutions. For example, the generative AI automatically organizes merits/demerits, a cost, an introduction period, a risk, the number of past successful cases, and the like for each option, such as “Plan A: introduction of an automation tool, Plan B: reduction of manual work by reviewing a business flow, Plan C: utilization of outsourcing”, and supports the employee to select an optimal solution. Furthermore, a reference document, template, checklist, FAQ, related law, external vendor information, and the like are also automatically linked and presented for each solution. Specifically, the solution presentation unit introduces a multi-agent reinforcement learning architecture. The system virtually constructs evaluation agents having a plurality of different viewpoints. The system inputs a plurality of generated solution candidates to each agent. The system expresses each solution candidate as a multidimensional feature vector. The feature vector includes elements such as a cost index, an introduction period, and a risk score. The evaluation agent executes inference using a neural network for the input vector. The agent calculates an expected reward value of each candidate. The system aggregates the calculated expected reward values. The system outputs a comprehensive evaluation matrix of each candidate. The system dynamically links related information using a knowledge graph. The system searches the knowledge graph using a keyword of the solution as a node. The system specifies a node of a related document or template. The system acquires a URI of the specified node. The system embeds the acquired URI as metadata of the solution. The system provides objective and multifaceted comparison information by these processes. The system supports data-driven decision making eliminating human bias. The system significantly reduces time required for information collection. The system is applied as a strategy planning support of a corporate planning department or an alternative evaluation tool in project management.

The execution support unit is implemented on the server side, automatically breaks down and generates a task necessary for executing the solution presented by the generative AI, and registers the task in cooperation with a task management tool via an API. For example, a plurality of tasks such as “automation tool introduction preparation”, “vendor selection”, “internal approval application”, “test operation”, “production introduction”, “manual creation”, “employee education”, and “effect measurement” are automatically generated in chronological order, and reflected on a task management screen of the employee. A progress status of the task can be updated by the employee from the terminal, and progress information is aggregated in the server. When progress is delayed or a delay of the task occurs, the generative AI can also automatically generate a reminder notification or additional advice, and push-notify the terminal side. For example, a specific action is prompted, such as “vendor selection is delayed by one week. Re-presentation of a candidate list is possible” and “approval of an internal approval application is delayed. Do you want to send a reminder to an approver?”. Specifically, the execution support unit executes a task breakdown algorithm using a sequence conversion model. The system inputs a text vector of the presented solution to the sequence conversion model. The model simultaneously executes syntax analysis and semantic role labeling. The model extracts an action verb, an object, and a conditional clause from the text. The model generates a task node from the extracted elements. The model infers a dependency relationship between tasks. The model generates an edge indicating the dependency relationship. The system outputs directed acyclic graph structure data composed of the task node and the edge. The system converts the output graph structure data into an API format of the task management tool. The system registers the task in an external system by asynchronous communication via an API gateway. The system executes a progress monitoring algorithm in the background. The algorithm monitors a digestion status of each task using time-series data analysis. The system constructs a delay prediction model using a recurrent neural network such as a long short-term memory network. The system inputs a past task execution history and current progress data to the delay prediction model. The model outputs a probability that each task is completed within a deadline as a floating-point score. The system detects an abnormality when the completion probability falls below a threshold. The system activates a push notification generation module triggered by the abnormality detection. The system generates a reminder text including a specific recovery measure. The system transmits the generated text to the terminal. The system realizes complete automation of project management. The system prevents omission of a task due to a human error. The system is applied to progress management of a large-scale project or task automation of daily business.

The effect measurement unit is implemented on the server side, and collects an execution result of the task and feedback from the employee. For example, a quantitative effect index is automatically aggregated, such as “a delay in invoice issuance has decreased from an average of 5 cases per month to 0 cases”, “a work time has been shortened from 30 minutes to 10 minutes per case”, and “the number of days required for a new contract procedure has been shortened from 10 days to 2 days”. In addition, qualitative feedback is also collected, such as “internal coordination was difficult at the time of introduction”, “there was an unclear point in an operation method of the tool”, and “inquiries from business partners increased”, and the generative AI automatically performs text mining and sentiment analysis. For example, when the employee inputs “after introduction, business was significantly streamlined, but it took time for initial setting work”, the generative AI extracts an improvement point such as “it is necessary to strengthen a support system for initial setting”. Specifically, the effect measurement unit includes a multimodal data integrated processing platform. The system acquires a numerical data array acquired from the task management tool and a token sequence of a feedback text input from the employee. The system normalizes the numerical data array. The system inputs the text token sequence to a bidirectional transformer model. The model analyzes a context of the text from both directions. The model outputs a positive or negative sentiment probability score. The model outputs an index of a start position and an end position of a text span indicating the improvement point. The system encodes the extracted text span as an improvement proposal vector. The system combines the normalized numerical data, the sentiment probability score, and the improvement proposal vector. The system inputs the combined tensor to an integrated analysis model. The integrated analysis model calculates a comprehensive score of a KPI achievement rate. The system stores the calculated comprehensive score in a database. The system executes a topic modeling algorithm. The algorithm estimates a distribution of a potential topic from a large amount of qualitative feedback. The system automatically clusters similar improvement points. The system self-evaluates prediction accuracy of the model using a loss function. The system continuously updates a weight of the model using an error backpropagation method. The system objectively evaluates qualitative human sentiments and opinions as quantitative data. The system accurately measures an effect of a measure. The system is applied as a personnel evaluation system or a PDCA cycle support tool for business improvement.

The continuous improvement unit is implemented on the server side, and the generative AI analyzes an issue resolution status of all employees, a past case, and feedback information obtained by the effect measurement unit chronologically and by attribute. For example, a tendency and a potential risk of an entire organization are extracted, such as “in the accounting department, invoice-related issues occur intensively in April every year”, “in the sales department, issues related to efficiency improvement of estimate creation have been reported multiple times”, and “there are many issues common to feedback from newly joined employees”. Based on these analysis results, the generative AI automatically generates an event with a high recurrence risk, a preventive measure, and an improvement proposal, and periodically distributes a report to a management layer or a management department. For example, a specific action plan can be presented, such as “recommending company-wide standardization of automation of invoice issuance business”, “distributing a digitization manual for a new contract procedure to all employees”, “proposing a review of a business flow of a specific department”, and “strengthening a business manual for new employees”. Specifically, the continuous improvement unit executes a multidimensional time-series clustering algorithm. The system combines an issue vector, a time stamp, and attribute data of all employees. The system inputs the combined high-dimensional tensor to a clustering model. The model extends and applies a density-based spatial clustering algorithm to a multidimensional space. The model specifies a dense region of data. The model outputs a cluster center vector. The system analyzes a chronological transition of each cluster. The system calculates a trend prediction score. The system implements an anomaly detection model using an autoencoder. The system causes the autoencoder to learn data of a normal business process. The system compresses input data to a low dimension and then restores it to an original dimension. The system calculates a reconstruction error between the input data and the restored data. The system extracts data whose reconstruction error exceeds a threshold as a potential risk. The system inputs the extracted risk data and the trend prediction score to a report generation model. The report generation model converts structured data into a natural language text. The model outputs a report text including an action plan for the management layer. The system early discovers a potential issue of the entire organization before a human recognizes it. The system supports data-driven proactive management decision making. The system is applied as a company-wide risk management system or a back-end analysis engine of a management dashboard.

Furthermore, for example, even when an employee voluntarily posts a case solved in the past, the generative AI automatically performs summarization, classification, tagging, and association with a similar case of posted contents, and contributes to quality improvement of a knowledge base. For example, “when Sato in the sales department posts a case of succeeding in digitization of a new business partner contract, the generative AI automatically assigns tags such as ‘new contract’, ‘digitization’, and ‘sales department’, and links it with a related past case”. In addition, when a plurality of employees input a similar issue at the same time, the generative AI can automatically group them and present a solution collectively as a common issue. For example, “when an issue of ‘preparation of a telework environment’ occurs simultaneously in a plurality of departments, the generative AI proposes a company-wide countermeasure, and cross-sectionally manages a progress status of each department”. Specifically, the system implements a multi-label classification neural network as an automatic tagging model. The system converts the posted text data into a TF-IDF vector or a dense distributed representation vector. The system inputs the converted vector to a classification network. The network extracts a feature through a plurality of hidden layers. The network applies a sigmoid function in an output layer. The network outputs a probability distribution vector for each predefined tag. The system automatically assigns all tags whose probability exceeds a threshold. The system models a relationship between cases using a graph neural network. The system constructs a graph in which each case is a node and a similarity between cases is a weight of an edge. The system executes a graph convolution operation. The operation aggregates features of adjacent nodes. The system updates a representation vector of the node. The system dynamically links a similar case based on the updated representation vector. The system executes dynamic grouping using a hierarchical clustering algorithm. The system calculates a distance matrix between a plurality of issue vectors input at the same time. The system combines issues with a short distance bottom-up. The system constructs a cluster tree. The system divides the tree at an optimal depth. The system generates a common issue group. The system realizes self-organization of the knowledge base. The system dramatically improves information search efficiency. The system is applied to an automatic organization function of an internal SNS or a company-wide cross-sectional project launch support system.

In addition, even when a person in charge or business contents are changed due to organizational restructuring, personnel transfer, or the like, the generative AI automatically updates employee attribute information so that optimal case search and solution presentation are continued. For example, it is also possible to cooperate with an external business system or groupware to acquire and reflect the latest organization information and business process information in real time. For example, it flexibly responds to an organizational change, such as “an employee newly assigned to the accounting department due to personnel transfer can immediately refer to a past accounting department case” or “automatically recommending a past similar department case for a department newly established by organizational restructuring”. Specifically, the system implements an API cooperation mechanism in an attribute information update module. The system periodically acquires update difference data from an external personnel system or groupware. The system parses the acquired difference data as structured data in a JSON format. The system executes a data synchronization algorithm. The algorithm safely updates a corresponding record in an internal database by transaction processing. The system dynamically recalculates an employee profile vector based on the updated attribute information. The system acquires an embedding vector of a new affiliation department or job title. The system synthesizes it with an existing profile vector. The system outputs an updated high-dimensional profile tensor. The system restarts a recommendation engine triggered by the update of the profile vector. The recommendation engine adopts a hybrid model of collaborative filtering and content-based. The engine receives the new profile tensor as an input. The engine outputs a list of case IDs to be recommended to the employee and a predicted evaluation score. The system immediately updates display contents of a user interface based on the output list. The system completely prevents obsolescence of information accompanying an organizational change. The system always maintains personalization accuracy adapted to the latest organizational state. The system is applied to onboarding support at the time of personnel transfer in a large-scale enterprise or a dynamic access authority management system.

Furthermore, for example, when cooperation with an external vendor or a consultant is necessary, the generative AI extracts a past external cooperation case, and specifically presents a vendor selection criterion, a point of contract negotiation, a note at the time of outsourcing, and the like. For example, know-how of external resource utilization such as “an external vendor selection case at the time of IT system introduction” and “a risk management case at the time of an outsourcing contract” can also be systematically utilized. Specifically, the system incorporates a named entity extraction technology into an external cooperation case extraction model. The system inputs an issue text vector to a hybrid model of a bidirectional long short-term memory network and a conditional random field. The model predicts a label sequence for each token in a text. The model outputs structured entity data such as a vendor name, a contract condition, and a risk factor. The system maps the extracted entity data to a knowledge graph. The system executes a relationship inference algorithm on the knowledge graph. The algorithm discovers a hidden link between entities. The system automatically generates a selection criterion matrix based on an inference result. The system compares feature vectors of a past success case and failure case. The system learns a decision boundary using a support vector machine. The system inputs a parameter of a new outsourcing project. The system outputs a success probability as a score. The system generates a risk warning text when the score is low. The system optimizes a process of external resource procurement. The system significantly reduces a contractual trouble or a project failure risk. The system is applied as a vendor management system of a purchasing department or a contract examination support tool of a legal department.

In this way, the embodiment of the present invention realizes automation and optimization of the entire issue resolution process, aggregation and utilization of personalized know-how, business efficiency improvement, and continuous evolution of organizational knowledge while clarifying role sharing between a server and a terminal with the generative AI as an essential core technology. Main processing of each unit is realized on the server side, and the terminal side mainly bears a user interface, an input assistance function, notification reception, progress input, and the like. The generative AI is utilized one by one in every scene of the entire system, such as natural language understanding, semantic search, automatic task generation, effect analysis, cross-organizational knowledge extraction/report generation, summarization/classification/tagging of posted contents, grouping, and external system cooperation. Thereby, it is possible to dramatically improve the issue resolution capability of each employee and the productivity and competitiveness of the entire organization. Specifically, the system adopts a microservice architecture to construct the entire system. The system deploys each AI module such as natural language understanding, semantic search, and automatic task generation as an independent container. The system uses a lightweight remote procedure call for inter-container communication. The system loosely couples each module. The system automatically scales out only a specific module using a container orchestration tool when a load concentrates on the module. The system introduces a distributed learning framework. The system executes online learning using new issue data and feedback data accumulated daily. The system applies transfer learning to a pre-trained foundation model. The system continuously updates to a model specialized in a business domain peculiar to the company. The system periodically synchronizes weight parameters of the model. The system improves robustness of the entire system. The system minimizes processing delay. The system realizes a self-evolving system in which inference accuracy of the AI improves as operation continues. The system is integrated and applied to all business systems as a core foundation promoting digital transformation of an enterprise.

### System Configuration

The system according to the present embodiment comprises an issue input unit, a case search unit, a solution presentation unit, an execution support unit, an effect measurement unit, a continuous improvement unit, a user interface unit, a database management unit, and an external cooperation unit.

The issue input unit has a function for the employee to input a business issue in a natural language, and operates on a terminal such as a personal computer, a tablet terminal, or a smartphone, for example. The issue input unit includes a text input field, a voice input function, a chatbot-format interactive interface, and the like, and enables the employee to input a specific issue faced on site as it is, such as “issuance of an invoice is delayed”, “a contract procedure with a new business partner is complicated”, “an internal approval flow is complex and takes time”, “it takes time to create sales materials every time”, and “a procurement application for IT equipment is delayed”. When the input contents are ambiguous or information is missing, the issue input unit automatically generates an additional question such as “which business partner's invoice is it?”, “what is the frequency of the issuance delay?”, and “in which business process does a bottleneck occur?” using the generative AI, and interactively collects supplementary information. For example, when the employee inputs “creation of a contract is delayed”, the issue input unit generates a question such as “is it a new contract or a renewal contract?”, “what is the type of the contract?”, and “which department is involved?”, and collects information necessary for specifying the issue. As a specific example of a prompt sentence, “generate an additional question necessary for clarifying details and a background of the issue, a related business process, an occurrence frequency, an involved department, and the like based on the issue contents input by the employee” and the like are cited. Specifically, the issue input unit comprises a module that dynamically optimizes prompt engineering. The system combines a text vector of a user utterance and a past session history tensor. The system inputs the combined data to a dialogue state tracking model. The model holds a context of a current dialogue as a multidimensional vector. The model specifies a missing information slot. The system selects a prompt template for filling the specified information slot. The system injects a context vector into the selected template. The system outputs a query character string to be input to a large language model. The large language model analyzes the query character string. The large language model generates a natural and contextual additional question text. The system displays the generated text on the user interface. The system receives a response from the user and updates the information slot. The system repeats this process until all essential information slots are filled. The system reduces a burden on the user to input all information at once. The system naturally draws out a requirement through a dialogue. The system dramatically improves comprehensiveness and accuracy of information collection. The system is applied to an initial phase of system development requiring complex requirement definition or a primary reception system of customer support.

The case search unit operates on the server, and has a function of searching the internal case database based on the issue information received from the issue input unit and the attribute information of the employee (affiliation department, job title, work location, assigned business, years of experience, past issue resolution history, etc.). The case search unit performs keyword extraction, semantic similarity calculation, attribute matching, time-series analysis, business process similarity evaluation, past feedback evaluation, and the like using the generative AI, and preferentially extracts a case closest to a situation of the employee. For example, a plurality of specific past cases can be presented, such as “a person in charge in the accounting department solved a delay in invoice issuance by introducing an automation tool”, “the sales department shortened a procedure time by digitizing a new business partner contract”, “the IT department streamlined an approval process by digitizing a procurement application”, and “the general affairs department reduced an inventory management mistake by automating internal equipment management”. As a specific example of a prompt sentence, “extract a past case with the highest relevance from the internal case database based on the given issue contents and employee attribute information, and list them in descending order of similarity” and the like are cited. Specifically, the case search unit applies a retrieval-augmented generation architecture. The system combines an issue text and attribute data. The system inputs the combined data to an encoder as a prompt vector. The encoder outputs a high-dimensional search query vector. The system implements an approximate nearest neighbor search algorithm such as a hierarchical navigable small world graph. The system collates the search query vector against a case database of a scale of tens of millions of cases. The system extracts a candidate group of similar cases with a latency in milliseconds. The system applies a cross-encoder model to the extracted candidate group. The model simultaneously receives a pair of a query and each case text as an input. The model calculates an attention weight of both. The model outputs a more precise relevance score. The system reranks the candidate group based on the relevance score. The system extracts higher-ranked case data. The system passes the extracted case data to the subsequent solution presentation unit. The system realizes high-speed and high-accuracy search from a large-scale database. The system discovers a potential similar case that could not be discovered by a conventional keyword search. The system is applied to a field requiring advanced information search such as a patent search system or a medical literature search system.

The solution presentation unit has a function of automatically generating a specific solution and an implementation procedure according to a situation of the employee using the generative AI based on contents of the past case extracted by the case search unit. The solution presentation unit presents practical and detailed advice, such as “when introducing an automation tool for invoice issuance, it is recommended to follow a procedure of inventorying a current business flow, selecting a tool vendor, acquiring internal approval, test operation, production introduction, manual creation, employee education, and effect measurement after operation”, “when digitizing a new business partner contract, it is necessary to set cooperation with an electronic signature service, revise internal regulations, hold a briefing session for employees, create a guidance document for a business partner, and create an operation guideline for an electronic contract”, “for efficiency improvement of sales material creation, standardization of a template, reuse of a past material, utilization of an automatic summarization function by AI, and introduction of a proofreading checklist are effective”, and “for resolving a delay in an IT equipment procurement application, digitization of an application flow, automatic notification of an approval process, real-time visualization of a procurement status, and preparation of an FAQ are recommended”. In addition, as necessary, contact information to a person in charge of implementation of the corresponding case or a related department is also automatically guided so that the employee can directly receive advice. For example, specific contact information is presented, such as “the person in charge of this case is Tanaka in the management department, and an extension number is 1234”, “the related department is the information system department, and an inquiry form is here”, and “contact information of a project leader who solved a similar issue in the past can be searched on an internal SNS”. As a specific example of a prompt sentence, “comprehensively generate an optimal solution, its implementation procedure, notes, reference materials, and contact information based on the contents of the extracted past case and the current situation of the employee” and the like are cited. Specifically, the solution presentation unit executes an inference process of a fine-tuned large language model. The system combines a searched case text group and a prompt indicating the current situation of the user. The system inputs the combined token sequence to the large language model. The model has an architecture in which a plurality of layers of decoder blocks of a transformer are stacked. The model calculates self-attention of the input token sequence. The model outputs structured JSON format data or a markdown text indicating each step of the solution. The system applies a beam search algorithm at the time of output generation. The algorithm calculates probabilities of a plurality of word sequences and selects an optimal sequence. The system executes rule-based filtering processing on the output text. The processing verifies whether a prohibited term or a contradictory procedure is included in the generated text using a regular expression. The system adopts only a text that has passed the verification as a final solution. The system collates metadata such as contact information with an internal directory API to ensure accuracy. The system automatically generates an executable and safe solution. The system eliminates a business risk due to inappropriate advice. The system is applied to a business support system of a financial institution or a diagnosis support system of a medical institution where a compliance check is strictly required.

The execution support unit has a function of automatically breaking down and generating a task necessary for executing the solution presented by the solution presentation unit, and registering the task in cooperation with a task management tool via an API. The execution support unit automatically generates a plurality of tasks in chronological order, such as “preparation for automation tool introduction”, “vendor selection”, “internal approval application”, “test operation”, “production introduction”, “manual creation”, “employee education”, and “effect measurement”, and reflects them on a task management screen of the employee. A progress status of the task can be updated by the employee from the terminal, and progress information is aggregated in the server. For example, a reminder notification or additional advice according to the progress is automatically generated and push-notified to the terminal side, such as “vendor selection is delayed by one week. Re-presentation of a candidate list is possible”, “approval of an internal approval application is delayed. Do you want to send a reminder to an approver?”, “a result report of test operation has not been submitted. Do you want to re-notify a submission deadline?”, and “progress of a manual creation task is 50%. Allocation of an additional resource is proposed”. As a specific example of a prompt sentence, “break down a task necessary for executing the presented solution, and generate contents, a person in charge, a deadline, a progress management method, and reminder notification contents of each task” and the like are cited. Specifically, the execution support unit implements a task dependency extraction model. The system inputs a solution text vector to a pipeline of a parser and a semantic role labeler. The pipeline extracts a subject and an object of an action and a temporal constraint from a text. The system outputs structured array data including a task name, a person in charge, and a deadline from the extracted elements. The system executes an optimal schedule generation algorithm using reinforcement learning. The algorithm searches for a schedule that minimizes an overall completion time in consideration of a required time and a resource constraint of each task. The system generates a dependency edge including a preceding task ID. The system collectively registers a task group in an external task management system by asynchronous communication via an API gateway. The system periodically polls a status of the registered task. The system activates a rule engine when detecting a progress delay. The rule engine determines an escalation level based on the number of delay days and importance of the task. The system dynamically generates a text of a reminder notification according to the determined level. The system push-transmits the generated notification to a terminal of a target person. The system realizes complete automation of project management. The system prevents a schedule delay due to a human error. The system is applied to iteration management of software development or a process management system of a construction project.

The effect measurement unit has a function of collecting an execution result of the task managed by the execution support unit and feedback from the employee, and measuring a quantitative and qualitative effect. The effect measurement unit automatically aggregates quantitative effect indicators such as, for example, “delay in invoice issuance has been reduced from an average of 5 cases per month to 0 cases”, “work time has been shortened from 30 minutes to 10 minutes per case”, “required days for a new contract procedure have been shortened from 10 days to 2 days”, and “man-hours for creating sales materials have been halved”. In addition, qualitative feedback such as “internal coordination was difficult at the time of introduction”, “there was an unclear point in an operation method of the tool”, “inquiries from business partners increased”, and “business understanding of new employees improved” is also collected, and the generative AI automatically performs text mining and sentiment analysis. For example, when the employee inputs “after the introduction, the business was greatly streamlined, but the initial setting work took time”, the effect measurement unit extracts an improvement point such as “it is necessary to strengthen a support system for initial setting”. A specific example of a prompt sentence includes “extract a quantitative effect indicator and a qualitative improvement point based on the task execution result and the employee feedback, and generate an effect measurement report”. Specifically, the effect measurement unit executes a multimodal data integration process. The system acquires a numerical data array such as a task completion time and the number of errors. The system acquires a token sequence of a feedback text. The system combines the numerical data array and the text token sequence to generate a multidimensional tensor. The system inputs the generated tensor to a multimodal neural network. The network includes a fully connected layer for numerical data and a transformer layer for text data in parallel. The network combines feature representations of both in an integration layer. The network outputs a floating-point score indicating a KPI achievement rate. The network outputs a text vector indicating an improvement proposal. The system executes a topic modeling algorithm such as Latent Dirichlet Allocation. The algorithm estimates a probability distribution of main topics from a text group of the qualitative feedback. The system automatically clusters the feedback based on the estimated topics. The system extracts a representative improvement point of each cluster. The system integrates the extracted improvement point and the KPI score to generate the effect measurement report. The system calculates an error between a predicted score and an actual result using a loss function. The system updates a weight of the network by backpropagation. The system integrally analyzes quantitative data and qualitative data. The system realizes highly accurate effect measurement and objective evaluation. The system is applied to an ROI analysis of a marketing measure and a user test evaluation system of product development.

The continuous improvement unit has a function of analyzing the issue resolution status of all employees, the past case, and the feedback information obtained by the effect measurement unit chronologically and by attribute by the generative AI, extracting a tendency and a potential risk of the entire organization, automatically generating an event with a high recurrence risk, a preventive measure, and an improvement proposal, and periodically distributing a report to the management layer or the management department. For example, the tendency and the risk of the entire organization are extracted, such as “in the accounting department, invoice-related issues occur intensively in April every year”, “in the sales department, issues related to efficiency improvement of estimate creation have been reported multiple times”, “there are many common issues in feedback from newly joined employees”, and “in the IT department, issues related to cooperation with external vendors are increasing”. Based on these analysis results, the generative AI presents a specific action plan such as “recommending company-wide standardization of automation of invoice issuance business”, “distributing a digitization manual for new contract procedures to all employees”, “proposing a review of a business flow of a specific department”, and “strengthening a business manual for new employees”. A specific example of a prompt sentence includes “analyze the issue resolution status and feedback of all employees chronologically and by attribute, extract the tendency of the entire organization, the recurrence risk, the preventive measure, and the improvement proposal, and generate a report for the management layer”. Specifically, the continuous improvement unit executes a recurrent neural network specialized for time-series data analysis and a large language model including a self-attention mechanism in cooperation. The continuous improvement unit acquires a multidimensional time-series tensor indicating the issue resolution status for the past twelve months as input data. The tensor has a data structure in which a five-dimensional numerical vector including a department ID, an issue category, an occurrence frequency, a required resolution time, and a sentiment score of feedback is arranged along a time axis. The large language model converts this time-series tensor into a 512-dimensional hidden state vector via an embedding layer. The large language model calculates a correlation of abnormal values unevenly distributed in a specific period or department using the self-attention mechanism. The large language model generates structured data including a floating-point number from 0 to 1 indicating a risk score and an improvement proposal text as output data. For example, the large language model outputs a probability distribution vector indicating a recurrence probability of an invoice processing delay in the accounting department in April together with a risk score of 0.85. The continuous improvement unit inputs this output result to a subsequent report generation module. When the risk score exceeds a preset threshold of 0.7, the report generation module dynamically generates a dashboard screen including an emergency alert for the management layer. With this configuration, the system specifies a hidden correlation between multidimensional data, which is difficult for a human to visually grasp, by a matrix operation in a high-dimensional space. The system realizes early discovery and prevention of an organizational risk, and exhibits technical effects of efficiency improvement of data management and optimization of computational resources. The present technology is suitably applied to an automatic audit and resource reallocation system of a business process in a large-scale intra-enterprise network.

A user interface unit is implemented on the terminal side, and provides a screen and an operation system for the employee to perform issue input, solution browsing, task progress input, feedback transmission, notification reception, and the like. For example, an issue input screen, a solution presentation screen, a task management screen, an effect measurement screen, a feedback input screen, a notification pop-up, and the like are provided. The user interface unit can also allow the generative AI to automatically adjust an optimal screen configuration and input assistance based on an operation history and a usage tendency of the employee. For example, “automatic display of frequently used issue templates”, “input completion from past input history”, “automatic reminder display at the time of progress delay”, “automatic question generation at the time of feedback input”, and the like are possible. Specifically, the user interface unit includes a dynamic rendering engine and a reinforcement learning-based layout optimization model. The layout optimization model acquires a feature vector including a past screen transition history of a user, coordinate data of a mouse click, a stay time, and the number of input characters as input data. The feature vector is configured as a 256-dimensional numerical array. The layout optimization model processes the feature vector using a multilayer perceptron. The layout optimization model generates a score vector indicating a display priority of each UI component and a coordinate matrix of a recommended screen layout as output data. For example, the layout optimization model outputs an XY coordinate value indicating a display position of an issue input form and a text array of input completion candidates. The user interface unit inputs this output result to a subsequent drawing processing module. The drawing processing module executes a branching process of arranging a component with the highest priority in the center of the screen based on the score vector and hiding an unnecessary component. With this configuration, unlike a conventional interface depending on a static screen design, the system executes adaptive screen reconfiguration according to an operation context of the user in real time. The system exhibits technical effects of reducing an input load of the user and reducing a CPU load and memory consumption required for a drawing process on the terminal side. The present technology is suitably applied to a cloud-based business support application in which various devices coexist and an accessibility improvement system using line-of-sight measurement data.

A database management unit is implemented on the server side, and centrally manages data of the entire system, such as a case database, a task management database, an effect measurement database, an employee attribute database, and a feedback database. For example, registration/update/deletion of a past case, recording of task progress, aggregation of effect measurement data, management of employee information, accumulation of feedback, storage of external cooperation data, and the like are performed. The database management unit aims to optimize the database by allowing the generative AI to automatically execute data quality check, deduplication, tagging, classification, summarization, association, and the like. Specifically, the database management unit includes a distributed graph database and a data cleansing model based on natural language processing. The data cleansing model acquires a character string array including newly registered unstructured text data and metadata of an existing record as input data. The character string array is converted into a 768-dimensional word embedding tensor through a word tokenization process and a stop word removal process. The data cleansing model calculates a semantic distance between new data and existing data using a cosine similarity calculation algorithm. The data cleansing model generates a score indicating a duplication probability and a list of automatically generated hierarchical classification tags as output data. For example, the data cleansing model outputs a numerical value of a duplication probability of 0.92 and an array of metadata tags such as accounting business and invoice processing. The database management unit inputs this output result to a subsequent record integration module. When the duplication probability exceeds a threshold of 0.9, the record integration module executes a branching process of merging the new data into the graph database as a sub-node of the existing record. With this configuration, the system eliminates manual data organization work by a human, and executes autonomous optimization of a data structure based on similarity determination in a high-dimensional vector space. The system exhibits technical effects of improving a search speed of the database and suppressing wasteful consumption of a storage capacity. The present technology is suitably applied to a large-scale knowledge management system and a master data integration platform between a plurality of systems.

An external cooperation unit is implemented on the server side, and performs API cooperation with an external business system, groupware, an electronic contract service, an external vendor system, an SNS, a mail system, and the like. For example, automatic acquisition of organizational restructuring and personnel transfer information, cooperation of a contract history with an external vendor, data cooperation with an electronic contract service, import of an external FAQ and a knowledge base, search for a person in charge on an SNS, notification distribution by mail, and the like are performed. The external cooperation unit aims to integrate with an internal database by allowing the generative AI to automatically execute summarization, classification, tagging, and association of external data. Specifically, the external cooperation unit includes an API gateway that controls an asynchronous communication protocol and a transformer model for data schema conversion. The transformer model acquires payload data in a JSON format acquired from an external system and a byte array including communication header information as input data. Since the payload data has a different data structure for each system, the external cooperation unit flattens a key-value pair into a one-dimensional vector as a preprocessing. The transformer model maps a correspondence relationship between each element of the external data and a standard schema of the internal database using a self-attention mechanism. The transformer model generates a standardized structured data object and a probability vector indicating a certainty factor of data conversion as output data. For example, the transformer model outputs a data set obtained by converting a contract date and a signer name acquired from an external electronic contract service into an internal standard format, and a numerical value of a certainty factor of 0.98. The external cooperation unit inputs this output result to a subsequent data routing module. When the certainty factor exceeds a threshold of 0.8, the data routing module executes a process of directly writing the converted data into the internal database. With this configuration, the system does not depend on static rule-based data mapping, and realizes dynamic schema conversion based on semantic understanding by an operation in a high-dimensional space. The system exhibits technical effects of reducing development man-hours required for data integration between systems and preventing a communication error and data loss. The present technology is suitably applied to an enterprise service bus that integrates a plurality of cloud services and a data synchronization system in a heterogeneous environment.

As described above, the system according to the present embodiment includes the issue input unit, the case search unit, the solution presentation unit, the execution support unit, the effect measurement unit, the continuous improvement unit, the user interface unit, the database management unit, and the external cooperation unit, and each unit executes an advanced process one by one utilizing the generative AI, and comprehensively and automatically supports from issue resolution of each employee to knowledge aggregation, business improvement, and risk prevention of the entire organization. Specifically, the system includes a control platform that integrally orchestrates a plurality of specialized neural network models on a microservice architecture. The control platform acquires a processing request event asynchronously transmitted from each unit, metrics data indicating a usage status of system resources, and a multidimensional state vector including session information of a user as input data. The control platform dynamically determines an allocation amount of a GPU memory and the number of threads for each generative AI model using a reinforcement learning-based resource allocation algorithm. The control platform generates a resource allocation command for each container and a queuing matrix indicating a priority of processing as output data. For example, the control platform outputs a command to allocate two GPU instances to the case search unit, and a scheduling flag that gives the highest priority to processing of the user interface unit requiring real-time performance. The system inputs this output result to a subsequent container orchestration engine. The container orchestration engine automatically executes start and stop of a virtual machine according to the command. With this configuration, the system goes beyond mere automation of a business process, and realizes a technical improvement at a hardware level, which is dynamic optimization of computational resources inside a computer system. The system exhibits technical effects of maximizing processing throughput of the entire system and minimizing latency at a peak time. The present technology is suitably applied to a cloud-native application accompanied by a large-scale traffic fluctuation and a distributed processing system in an edge computing environment.

### Implementation Steps

Step 1: Issue Input and Information Collection The employee inputs a business issue in a natural language from the user interface of the terminal. An input method is diverse, such as text input, voice input, and a chatbot format, and a specific issue faced on site can be input as it is, such as, for example, “issuance of an invoice is delayed”, “a contract procedure with a new business partner is complicated”, “an internal approval flow is complex and takes time”, “it takes time to create sales materials every time”, and “a procurement application for IT equipment is delayed”. When input contents are ambiguous or information is missing, the generative AI automatically generates an additional question, and interactively collects supplementary information on the terminal. A specific example of a prompt sentence includes “generate an additional question necessary for clarifying details and a background of the issue, a related business process, an occurrence frequency, an involved department, and the like based on the issue contents input by the employee”. Specifically, in this step, the system executes a voice recognition model and a convolutional neural network for intention classification in cooperation. The system acquires voice waveform data acquired from a user or a time-series array of keystrokes as input data. In the case of voice input, the system executes a preprocessing of converting a voice waveform into a two-dimensional acoustic feature tensor using a mel-frequency cepstrum coefficient. The voice recognition model processes this acoustic feature tensor and outputs a text character string. Subsequently, the intention classification model acquires a 300-dimensional tensor obtained by converting the text character string into a word embedding vector as input data. The intention classification model generates a score indicating a degree of missing information and a one-hot vector indicating a missing information category as output data. For example, the intention classification model outputs an information missing degree score of 0.88 and a vector indicating that categories of an occurrence frequency and an involved department are missing. The system inputs this output result to a subsequent dialogue generation module. When the information missing degree score exceeds a threshold of 0.5, the dialogue generation module executes a branching process of dynamically generating an additional question text for filling the missing category and displaying it on the screen of the terminal. With this configuration, the system does not depend on an intuitive judgment of a human, quantitatively evaluates information entropy of input data, and mechanically collects a necessary parameter. The system exhibits technical effects of reducing an error rate in a subsequent process and ensuring completeness of data input. The present technology is suitably applied to an automatic triage system in customer support and an initial medical interview system in a medical field.

Step 2: Analysis of Issue Contents and Keyword Extraction On the server side, the generative AI receives issue input contents, and performs keyword extraction, intention analysis, and context understanding using a natural language processing technology. For example, keywords such as “invoice”, “issuance”, “delay”, “accounting department”, and “end of month” are extracted to grasp a gist and a background of the issue. Furthermore, attribute information of the employee (affiliation department, job title, work location, assigned business, years of experience, past issue resolution history, etc.) is also combined and analyzed. A specific example of a prompt sentence includes “extract a main business keyword, a related department, an occurrence period, and a background factor from the given issue contents”. Specifically, in this step, the system executes an analysis engine including a named entity extraction model and a context-dependent language model. The analysis engine acquires issue text data collected in Step 1 and a metadata vector including the attribute information of the employee as input data. The metadata vector is configured as a 64-dimensional numerical array obtained by normalizing a department ID and years of experience. The analysis engine executes a preprocessing of tokenizing the text data in units of subwords and combining it with the metadata vector to generate an integrated input tensor. The language model calculates a dependency relationship between each token in the integrated input tensor using a multi-layer self-attention mechanism. The language model generates a list of extracted keywords, an attention weight indicating an importance of each keyword, and a probability distribution vector indicating a classification category of the issue as output data. For example, the language model outputs a vector indicating an attention weight of 0.95 for a keyword of invoice and a probability of 0.99 belonging to an accounting business category. The system inputs this output result to a subsequent index generation module. The index generation module executes a process of extracting only a keyword whose attention weight exceeds a predetermined threshold and generating a hash key for search. With this configuration, the system realizes highly accurate feature extraction excluding noise by a vector operation of a contextual meaning in a high-dimensional space, instead of simple character string matching. The system exhibits technical effects of reducing a calculation amount in a search process and dramatically improving search accuracy. The present technology is suitably applied to a patent search system that extracts specific technical information from a huge amount of internal documents and a failure cause identification system from log data.

Step 3: Search of Internal Case Database The case database on the server is searched based on the keyword extracted by the generative AI and the attribute information of the employee. In the case database, contents of an issue that occurred in the past, a solution, an implementation procedure, a person in charge, an occurrence department, an occurrence period, a period until resolution, an obtained effect, a related document and template, an FAQ, a reference material, external vendor information, a business flow diagram, a checklist, an internal regulation, and the like are systematically recorded. The generative AI performs keyword matching, semantic similarity calculation, attribute matching, time-series analysis, business process similarity evaluation, past feedback evaluation, and the like, and preferentially extracts a case with the highest relevance. A specific example of a prompt sentence includes “extract a past case with the highest relevance from the internal case database based on the given issue contents and employee attribute information, and list them in descending order of similarity”. Specifically, in this step, the system executes a search engine including an approximate nearest neighbor search algorithm and a bidirectional encoder representation model. The search engine acquires the hash key for search generated in Step 2, an embedding vector of an issue text, and a metadata vector of an employee attribute as input data. The search engine executes a preprocessing of combining these input data and generating a 1024-dimensional query vector. The search engine calculates a cosine similarity based on an inner product calculation for a group of millions of past case vectors stored in advance in the case database. The search engine generates a case ID list of top N cases with a high similarity score and structured data including a similarity score of each case as output data. For example, the search engine outputs a similarity score of 0.91 for a case ID 12345 and a similarity score of 0.85 for a case ID 67890. The system inputs this output result to a subsequent ranking module. The ranking module executes a sorting process of multiplying the similarity score by a weighting coefficient based on a past feedback evaluation to determine a final display order. With this configuration, the system overcomes a limit of an exact match search in a conventional relational database, and extracts a semantically related case at high speed and comprehensively by distance calculation in a high-dimensional vector space. The system exhibits technical effects of improving a recall rate of search and reducing the number of accesses of disk IO to improve a processing speed. The present technology is suitably applied to a similar case search in an electronic medical record system and a search system for a similar bug fix history in a source code repository.

Step 4: Automatic generation and presentation of a solution and an implementation procedure The generative AI automatically generates a specific solution and an implementation procedure according to a situation of the employee based on contents of the extracted past case. For example, practical and detailed advice is presented, such as “When introducing an automation tool for invoice issuance, it is recommended to follow a procedure of taking an inventory of a current business flow, selecting a tool vendor, obtaining internal approval, test operation, production introduction, manual creation, employee education, and effect measurement after operation” and “When digitizing a new business partner contract, it is necessary to set up cooperation with an electronic signature service, revise internal regulations, hold a briefing session for employees, create a guidance document for business partners, and create an operation guideline for electronic contracts”. As necessary, contact information to a person in charge of implementation of the corresponding case or a related department is also automatically guided. A specific example of a prompt sentence is “Comprehensively generate an optimal solution, its implementation procedure, notes, reference materials, and contact information based on the contents of the extracted past case and the current situation of the employee”. Specifically, in this step, the system executes a generation module including a sequence conversion model and a knowledge graph inference engine. The generation module acquires, as input data, text data of a top case extracted in step 3, a state vector indicating a current business context of the employee, and a logical rule set indicating a constraint condition of internal regulations. The generation module executes preprocessing of filtering a step that does not conform to a current authority or department of the employee from a resolution procedure of the past case using the knowledge graph inference engine. The sequence conversion model performs an autoregressive decoding process based on the filtered procedure data to generate a new procedure text. The sequence conversion model generates, as output data, data in a JSON format including an array of tasks arranged in chronological order, a score indicating an execution difficulty level of each task, and a URI link of a related internal resource. For example, the sequence conversion model outputs a text of taking an inventory of the current business flow as a first step, a difficulty score of 0.3, and a download link of a business flow diagram template. The system inputs this output result to a subsequent rendering engine. The rendering engine executes a process of dynamically changing a font size on a screen or a display of a warning icon according to the difficulty score. With this configuration, the system realizes dynamic reconstruction of a procedure based on a current constraint condition by a logical operation inside a computer, instead of presenting a past static document as it is. The system exhibits a technical effect of preventing a business error due to presentation of an inappropriate procedure and improving accuracy of information presentation. This technology is suitably applied to a dynamic work procedure manual generation system in a manufacturing site or a failure recovery navigation system of an IT infrastructure.

Step 5: Task breakdown, execution support, and progress management A task necessary for executing the solution presented by the generative AI is automatically broken down and generated, and the task is registered in cooperation with a task management tool via an API. For example, a plurality of tasks such as “preparation for introducing an automation tool”, “vendor selection”, “internal approval application”, “test operation”, “production introduction”, “manual creation”, “employee education”, and “effect measurement” are automatically generated in chronological order and reflected on a task management screen of the employee. A progress status of the task can be updated by the employee from a terminal, and progress information is aggregated in a server. When progress is delayed or a task delay occurs, a reminder notification or additional advice is automatically generated and push-notified to the terminal side. A specific example of a prompt sentence is “Break down a task necessary for executing the presented solution, and generate contents, a person in charge, a deadline, a progress management method, and reminder notification contents of each task”. Specifically, in this step, the system executes a task control engine including a dependency analysis parser and a reinforcement learning-based scheduling algorithm. The task control engine acquires, as input data, the task array generated in step 4, numerical data indicating a standard required time of each task, and a binary vector indicating a current calendar availability of the employee. The task control engine executes preprocessing of constructing a directed acyclic graph indicating a preceding/succeeding relationship between tasks using the dependency analysis parser. The scheduling algorithm collates this directed acyclic graph with the calendar availability, and calculates an optimal timeline that minimizes an overall completion period. The task control engine generates, as output data, a time stamp indicating a scheduled start date and time and a scheduled end date and time of each task, and a flag indicating that the task is on a critical path. For example, the task control engine outputs a time stamp of a start date and time and an end date and time, and a true value of a critical path flag for a vendor selection task. The system inputs this output result to a subsequent monitoring daemon. The monitoring daemon periodically compares a system clock with the time stamp, and automatically generates an interrupt process for escalation when a current time exceeds the scheduled end date and time and a progress flag is incomplete. With this configuration, the system eliminates schedule management depending on human manual input, and executes automatic scheduling and delay detection of a task by mathematical optimization based on graph theory. The system exhibits a technical effect of quantitatively reducing a delay risk of a project and minimizing a standby time of computer resources. This technology is suitably applied to control of an automatic build pipeline in large-scale software development or a dynamic recalculation system of a delivery route in a logistics network.

Step 6: Effect measurement and feedback collection An execution result of the task and feedback from the employee are collected, and a quantitative and qualitative effect is measured. For example, a quantitative effect index is automatically aggregated, such as “a delay in invoice issuance has decreased from an average of 5 cases per month to 0 cases”, “a work time has been shortened from 30 minutes to 10 minutes per case”, “the number of days required for a new contract procedure has been shortened from 10 days to 2 days”, and “man-hours for creating sales materials have been halved”. In addition, qualitative feedback is also collected, such as “internal coordination was difficult at the time of introduction”, “there was an unclear point in an operation method of a tool”, “inquiries from business partners increased”, and “business understanding of new employees improved”, and the generative AI automatically performs text mining and sentiment analysis. A specific example of a prompt sentence is “Extract a quantitative effect index and a qualitative improvement point based on a task execution result and employee feedback, and generate an effect measurement report”. Specifically, in this step, the system executes an evaluation engine including a statistical analysis module and a pre-trained language model for sentiment analysis. The evaluation engine acquires, as input data, an array of floating-point numbers indicating a processing time extracted from a system log before and after task completion, and a free-description feedback text input by a user. The evaluation engine executes preprocessing of performing an analysis of variance on the array of processing times and calculating a P value indicating a statistically significant difference. The language model tokenizes the feedback text and extracts a contextual feature via a multi-layer transformer network. The language model generates, as output data, a probability distribution vector indicating a ternary classification of positive, negative, and neutral, and a cluster ID indicating a topic of an improvement request. For example, the language model outputs a negative probability of 0.85 and a cluster ID indicating a topic related to operability. The system inputs this output result to a subsequent database update module. When the negative probability exceeds a threshold of 0.7, the database update module executes a penalty process of automatically subtracting a recommendation degree score of a corresponding past case. With this configuration, the system objectively and quantitatively evaluates effectiveness of a measure by combining statistical processing of log data and vector space mapping of a natural language without depending on subjective evaluation. The system exhibits a technical effect of autonomously maintaining and improving quality of a case database and continuously improving accuracy of a search result. This technology is suitably applied to an automatic analysis system of a product review in an e-commerce site or a learning effect measurement system in an online education platform.

Step 7: Continuous improvement and cross-organizational analysis The generative AI analyzes an issue resolution status of all employees, a past case, and feedback information obtained by the effect measurement unit chronologically and by attribute, extracts an issue tendency and a potential risk of an entire organization, automatically generates an event with a high recurrence risk, a preventive measure, and an improvement proposal, and periodically distributes a report to a management layer or a management department. For example, a tendency and a risk of the entire organization are extracted, such as “in an accounting department, invoice-related issues occur intensively in April every year”, “in a sales department, issues related to efficiency improvement of estimate creation have been reported multiple times”, “there are many issues common to feedback from newly joined employees”, and “in an IT department, issues related to cooperation with an external vendor are increasing”. A specific example of a prompt sentence is “Analyze an issue resolution status and feedback of all employees chronologically and by attribute, extract a tendency of an entire organization, a recurrence risk, a preventive measure, and a business improvement proposal, and generate a report for a management layer”. Specifically, in this step, the system executes an integrated analysis engine including a multivariate time-series prediction model and an anomaly detection algorithm. The integrated analysis engine acquires, as input data, a multidimensional tensor including an issue occurrence log for past several years collected from terminals of all employees, a required resolution time, and a sentiment score of feedback. The integrated analysis engine executes preprocessing of reducing a dimension of the multidimensional tensor using principal component analysis and removing noise. The prediction model processes the dimension-reduced time-series data using a long short-term memory network, and calculates an issue occurrence probability at a specific point in time in the future. The prediction model generates, as output data, a heat map matrix indicating a future risk prediction value for each department, and an alert flag indicating a sign of anomaly occurrence. For example, the prediction model outputs a matrix element indicating a risk prediction value of 0.92 in the accounting department in April, and a true value of the alert flag. The system inputs this output result to a subsequent report generation batch process. When the alert flag is true, the batch process automatically transmits a control signal prompting resource enhancement to a manager of a corresponding department. With this configuration, the system proactively specifies a future bottleneck by an advanced prediction operation based on a past data pattern, not limited to a reactive response. The system exhibits a technical effect of optimizing resource allocation of the entire organization and preventing an economic loss due to a system failure or a business delay. This technology is suitably applied to a demand prediction system of a supply chain in a large-scale manufacturing industry or a sign detection system of an unauthorized transaction in a financial institution.

### Specific Use Case

For example, when an employee belonging to an accounting department recognizes a business issue that an issuance delay frequently occurs in an invoice issuance business occurring at the end of every month and the employee is busy responding to inquiries from business partners, the employee first inputs “Issuance of an invoice is delayed every month. Reminders from business partners are increasing.” in a natural language to an issue input unit. When input contents are ambiguous or information is missing, the issue input unit automatically generates an additional question such as “Which business partner's invoice is it?”, “What is a frequency of the issuance delay?”, “In which business process is a bottleneck occurring?”, and “What was a countermeasure when a similar delay occurred in the past?” using generative AI, and interactively prompts the employee to input supplementary information. A specific example of a prompt sentence is “Generate an additional question necessary for specifying a cause of an invoice issuance delay and grasping details of a business process based on issue contents input by an employee”. Specifically, in the present embodiment, the system executes a syntax analyzer of an input text and a decision tree algorithm for missing information determination. The system acquires, as input data, a character string “Issuance of an invoice is delayed every month. Reminders from business partners are increasing.”. The syntax analyzer executes preprocessing of dividing this character string into morphemes, assigning a part-of-speech tag, and generating syntax tree data. The decision tree algorithm receives a pair of a noun and a verb extracted from the syntax tree data as a feature amount vector, and collates it with a predefined business issue ontology. The decision tree algorithm generates, as output data, a list of items that are not input among slots required on the ontology, and an importance score of each item. For example, the decision tree algorithm outputs a slot name of a target business partner and an importance score of 0.9. The system inputs this output result to a subsequent prompt generation module. The prompt generation module executes a process of dynamically synthesizing a question sentence in a natural language for filling a slot with the highest importance score from a template, and displaying it on a user interface. With this configuration, the system realizes a mechanism of forcibly complementing a necessary parameter based on a logical structure inside the system while allowing an ambiguous input by a user's free description. The system exhibits a technical effect of ensuring accuracy of a query in a subsequent search process and preventing waste of calculation resources due to an irrelevant search result. This technology is suitably applied to an automatic ticket issuing system in a help desk or an initial hearing system of a contract review in a legal department.

Next, after issue contents are determined, a case search unit extracts a keyword such as “invoice”, “issuance”, “delay”, “accounting department”, and “end of month” using generative AI, and searches an internal case database in combination with attribute information of an employee (accounting department affiliation, person in charge, work location, past issue resolution history, etc.). The case search unit performs semantic similarity calculation, attribute matching, and time-series analysis, and extracts a plurality of highly related past cases, such as “a person in charge of an accounting department solved a delay in invoice issuance by introducing an automation tool”, “an accounting department standardized an invoice issuance business and improved work efficiency”, “an accounting department reduced a delay by reviewing an invoice issuance flow”, and “an accounting department eliminated a bottleneck in invoice issuance by strengthening cooperation with an external vendor”. A specific example of a prompt sentence is “Extract a most highly related past case from an internal case database regarding an invoice issuance delay based on given issue contents and employee attribute information, and list them in descending order of similarity”. Specifically, in the present embodiment, the case search unit executes a vector database and a cross-encoder type re-ranking model. The case search unit acquires, as input data, a composite query vector including an extracted keyword group and employee attribute information. The composite query vector is configured as a 512-dimensional dense vector combining a text feature amount and a categorical variable. The case search unit executes an approximate nearest neighbor search on the vector database, and performs a primary search process of extracting 100 candidate case vectors from millions of records at high speed. Subsequently, the re-ranking model acquires, as input data, a pair of the composite query vector and each extracted case vector. The re-ranking model calculates a detailed semantic correspondence relationship between a query and a case using a self-attention mechanism. The re-ranking model generates, as output data, a floating-point number from 0 to 1 indicating a final relevance score for each case. For example, the re-ranking model outputs a relevance score of 0.95 for a case of introducing an automation tool. The case search unit inputs this output result to a subsequent display control module. The display control module executes a process of sorting cases in descending order of the relevance score and rendering only top five cases on a screen. With this configuration, the system eliminates a search method based on an appearance frequency of a simple keyword, and optimizes a trade-off between search speed and accuracy by a two-stage vector operation in a high-dimensional space. The system exhibits a technical effect of shortening a time until a user reaches a target case and reducing a CPU load of a server. This technology is suitably applied to a large-scale academic paper search engine or a prior art search system of patent documents.

A solution presentation unit automatically generates a specific solution and an implementation procedure according to a situation of an employee using generative AI based on contents of an extracted past case. For example, practical and detailed advice is presented, such as “When introducing an automation tool for invoice issuance, it is recommended to follow a procedure of taking an inventory of a current business flow, selecting a tool vendor, obtaining internal approval, test operation, production introduction, manual creation, employee education, and effect measurement after operation”, “For standardization of an invoice issuance business, creation of a business procedure manual, introduction of a checklist, review of business sharing among persons in charge, and utilization of a progress management table are effective”, and “For strengthening cooperation with an external vendor, implementation of a regular progress meeting, utilization of an information sharing tool, review of an outsourcing contract, and maintenance of an escalation rule when a trouble occurs are recommended”. In addition, as necessary, contact information to a person in charge of implementation of a corresponding case or a related department is also automatically guided, and specific contact information is presented, such as “A person in charge of this case is Tanaka of a management department”, “A related department is an information system department”, and “Contact information of a project leader who solved a similar issue in the past can be searched on an internal SNS”. A specific example of a prompt sentence is “Comprehensively generate an optimal solution for resolving an invoice issuance delay, its implementation procedure, notes, reference materials, and contact information based on contents of an extracted past case and a current situation of an employee”. Specifically, in the present embodiment, the solution presentation unit executes a large language model based on a retrieval-augmented generation architecture. The solution presentation unit acquires, as input data, a text chunk of an extracted past case, a binary flag indicating a current job title authority of an employee, and a record of a latest personnel information database acquired from an internal directory service. The solution presentation unit combines these input data as one prompt context, and executes a truncation process for keeping a token length within a limit. The large language model performs an inference process of extracting and reconstructing only a procedure executable by a current employee based on this context. The large language model generates, as output data, a procedure manual text structured in a markdown format, and a metadata tag including an employee ID of a related person in charge. For example, the large language model outputs a text of taking an inventory of a current business flow as a first step, and an employee ID 1029 indicating a person in charge of an information system department. The solution presentation unit inputs this output result to a subsequent link generation module. The link generation module executes a process of dynamically generating a URL for starting a direct message to an internal chat tool based on an employee ID, and embedding it in a text. With this configuration, the system dynamically converts past static information into executable actionable information in cooperation with real-time external data, instead of displaying it as it is. The system exhibits a technical effect of making a transition to a user's next action seamless and shortening a lead time of business execution. This technology is suitably applied to an internal portal system that navigates a complex internal procedure or an automatic playbook generation system for incident response.

An execution support unit automatically breaks down and generates a task necessary for executing a presented solution using generative AI, and registers the task in cooperation with a task management tool via an API. A plurality of tasks such as “preparation for introducing an automation tool”, “vendor selection”, “internal approval application”, “test operation”, “production introduction”, “manual creation”, “employee education”, and “effect measurement” are automatically generated in chronological order and reflected on a task management screen of an employee. When progress is delayed or a task delay occurs, a reminder notification or additional advice according to progress is automatically generated and push-notified to a terminal side, such as “Vendor selection is delayed by one week. A candidate list can be presented again” and “Approval of an internal approval application is delayed. Do you want to send a reminder to an approver?”. A specific example of a prompt sentence is “Break down a task necessary for executing a presented invoice issuance delay resolution measure, and generate contents, a person in charge, a deadline, a progress management method, and reminder notification contents of each task”. Specifically, in the present embodiment, the execution support unit executes a task dependency graph generation algorithm and an event-driven notification engine. The execution support unit acquires, as input data, a generated procedure manual text, a numerical matrix indicating a standard lead time of each task, and a current system date. The execution support unit executes preprocessing of extracting a verb phrase from a procedure manual text using natural language processing and defining it as a task node. The graph generation algorithm connects a preceding/succeeding relationship between task nodes as an edge, calculates a critical path, and calculates an absolute deadline date and time of each task. The execution support unit generates, as output data, a JSON array including a task ID, a task name, a deadline date and time, and a status flag. For example, the execution support unit outputs a task name of vendor selection, a UNIX time stamp indicating a deadline date and time, and a status flag indicating incomplete. The execution support unit inputs this output result to a subsequent task management database and notification engine. The notification engine monitors a database by a periodic polling process, and when detecting a record in which a current time exceeds a deadline date and time and a status flag is incomplete, automatically generates a payload for push notification and transmits it to a terminal. With this configuration, the system realizes strict state transition management based on a timer interrupt inside a computer and graph theory without depending on human memory or manual schedule management. The system exhibits a technical effect of physically preventing an execution omission of a task and minimizing a progress delay of an entire project. This technology is suitably applied to a large-scale workflow management system involving a plurality of departments or a sprint management tool in agile development.

An effect measurement unit collects an execution result of a task and feedback from an employee, and automatically aggregates a quantitative effect index, such as “a delay in invoice issuance has decreased from an average of 5 cases per month to 0 cases”, “a work time has been shortened from 30 minutes to 10 minutes per case”, “the number of reminders from business partners has decreased”, and “a business load has been reduced”. In addition, qualitative feedback is also collected, such as “internal coordination was difficult at the time of introduction”, “there was an unclear point in an operation method of a tool”, and “inquiries from business partners increased”, and generative AI automatically performs text mining and sentiment analysis. A specific example of a prompt sentence is “Extract a quantitative effect index and a qualitative improvement point of an invoice issuance delay resolution measure based on a task execution result and employee feedback, and generate an effect measurement report”. Specifically, in the present embodiment, the effect measurement unit executes a time-series data aggregation engine and an aspect-based sentiment analysis model. The effect measurement unit acquires, as input data, a time stamp log of invoice issuance extracted from a business system, and an array of feedback texts input by a user. The aggregation engine calculates a required time taken for an issuance process from a time stamp log, and executes preprocessing of calculating an average value and a variance before and after introduction of a measure. The sentiment analysis model converts a feedback text into a word vector, and extracts a local feature using a convolutional neural network. The sentiment analysis model generates, as output data, an evaluation matrix including a percentage value indicating a quantitative improvement rate and a sentiment polarity score for a specific topic. For example, the sentiment analysis model outputs numerical data of a 66% reduction in work time, and a negative score of 0.8 for a topic of operability of a tool. The effect measurement unit inputs this output result to a subsequent dashboard generation module. The dashboard generation module executes a process of dynamically generating a graph image to which a red warning highlight is added for a topic whose negative score exceeds a threshold of 0.7. With this configuration, the system integrally evaluates qualitative text data and quantitative log data on the same vector space, and calculates true effectiveness of a measure from multiple angles. The system exhibits a technical effect of eliminating manual data aggregation work by a human and shortening a calculation time required for generating an evaluation report. This technology is suitably applied to an ROI measurement system of a marketing campaign or an automatic evaluation system of a software usability test.

The continuous improvement unit extracts a tendency and a risk of the entire organization, such as “invoice-related issues frequently occur in the accounting department in April every year”, “there are many common issues in feedback from newly joined employees”, and “issues related to cooperation with external vendors are increasing”, by analyzing the issue resolution status of all employees, the past case, and the feedback information obtained by the effect measurement unit chronologically and by attribute using the generative AI. The generative AI presents a specific action plan, such as “recommending company-wide standardization of automation of invoice issuance business”, “strengthening a business manual for new employees”, and “developing a guideline for external vendor cooperation”, based on these analysis results. A specific example of a prompt sentence includes “Analyze the issue resolution status and feedback regarding the invoice issuance delay of all employees chronologically and by attribute, extract the tendency of the entire organization, the recurrence risk, the preventive measure, and the improvement proposal, and generate a report for the management layer”. Specifically, in the present embodiment, the continuous improvement unit executes an advanced analysis engine including a clustering algorithm and a causal inference model. The continuous improvement unit acquires an evaluation matrix output from the effect measurement unit, an attribute vector including an affiliation department and a joining year of the employee, and a timestamp of an issue occurrence date and time as input data. The continuous improvement unit constructs a multidimensional feature space by combining these data, and executes preprocessing of grouping similar issue patterns using a K-means method. The causal inference model probabilistically calculates a strength of a causal relationship between a specific attribute and an issue occurrence frequency using a Bayesian network. The causal inference model generates a score indicating an abnormality occurrence probability of a specific cluster and a list of factors estimated to be a root cause thereof as output data. For example, the causal inference model outputs an issue occurrence probability of 0.95 in the accounting department in April, and a factor list of assignment of a new employee as the root cause. The continuous improvement unit inputs this output result to a subsequent proposal generation module. When the abnormality occurrence probability exceeds a threshold, the proposal generation module executes a process of substituting a variable of the root cause into a predefined solution template and automatically synthesizing a text of strengthening the business manual for new employees. With this configuration, the system completes not only presentation of a mere correlation but also specification of a causal relationship based on a probabilistic model and derivation of a logical solution based thereon inside a computer. The system exhibits a technical effect of supporting decision-making of the management layer in a data-driven manner and improving accuracy of organizational risk management. The present technology is suitably applied to a call volume prediction and staffing optimization system in a large-scale call center, and a root cause analysis system for a quality defect in a manufacturing industry.

As described above, the system of the present invention can simultaneously realize issue resolution of an individual employee and knowledge aggregation and business improvement of the entire organization by utilizing the generative AI in each stage of issue input, information complementation, case search, solution presentation, task breakdown/execution support, effect measurement, and continuous improvement for a specific business issue of an invoice issuance delay. Specifically, the system adopts a pipeline architecture that asynchronously links a plurality of neural network models operating independently in each processing stage via an event-driven message queue. The system acquires a series of transaction data from an initial input text from a user to a final feedback as input data. Every time the model in each stage performs an inference process, the system caches an intermediate output result thereof in a shared in-memory database, and maintains a state in which a subsequent model can immediately refer to it. The system generates a flag indicating an individual issue resolution status and update difference data of a knowledge graph of the entire organization as output data. For example, the system outputs a command to update a status of a specific invoice issuance delay issue to resolved, and new edge data connecting an automation tool node and an accounting department node on the knowledge graph. The system asynchronously reconstructs an index of the case database in a background process using this output result. With this configuration, the system executes individual task processing and overall knowledge base update in parallel, and eliminates a processing bottleneck of the entire system. The system exhibits a technical effect of realizing real-time knowledge aggregation while maintaining data consistency, and ensuring scalability of the system. The present technology is suitably applied to a software development infrastructure that practices continuous integration and continuous delivery, and an AI assistant platform for enterprises that autonomously learns and evolves.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

An embodiment of a logistics center business optimization system of the present invention will be described more specifically and in detail. The system is composed of a server and a plurality of terminals, aggregates main processing functions such as an execution environment of generative AI, a case database, a task management system, an effect measurement module, an analysis/report generation function, and an external cooperation API on the server side, and includes a user interface, an input assistance function, a notification reception function, a progress input function, a voice recognition function, an image recognition function, and the like for an on-site worker or a manager to use on the terminal side. The terminal is composed of various devices such as a personal computer, a tablet terminal, a smartphone, a wearable terminal, a voice input device, smart glasses, a terminal with a barcode reader, and a terminal with an RFID reader installed at a work site in a logistics center, and the server is composed of a cloud environment or an on-premises high-performance computer group. Specifically, the system adopts a hybrid distributed processing architecture that fuses edge computing and cloud computing. The system arranges a lightweight convolutional neural network model on the terminal side, and arranges a large-scale language model of a hundreds of billions of parameters scale and a graph neural network on the server side. The system acquires a high-resolution video stream of 30 frames per second acquired from a camera of the smart glasses and a continuous stream of an identification ID of a package acquired from the RFID reader as input data. The edge model on the terminal side executes preprocessing of extracting skeletal coordinates of the worker and a bounding box of the package from the video stream in real time, and generates a feature vector in which a data size is compressed to one hundredth. The system transmits a metadata packet including the compressed feature vector and the identification ID to the server as output data. For example, the system outputs a packet including a time-series coordinate matrix indicating a picking operation of the worker and a package ID 12345. A processing module on the server side receives this packet, and executes subsequent processing of inferring a cause of work delay or a sign of an error using the large-scale language model. With this configuration, the system avoids transmission of raw data requiring a broadband network, and shares feature extraction on the edge side and advanced semantic analysis on the server side. The system exhibits a technical effect of dramatically reducing consumption of a network bandwidth and realizing real-time feedback with low latency in milliseconds. The present technology is suitably applied to a control system for an autonomous robot group in a huge warehouse having a vast site area, and a safety monitoring and flow line optimization system in a factory.

The issue input unit is implemented on the terminal side, and provides an interface for the on-site worker or the manager to input an issue faced during daily business in a natural language. For example, a text input field, a voice input function, a chatbot-format interactive UI, an image attachment function, a video attachment function, and the like are provided, and the worker can input a specific issue occurring on site as it is, such as “often mistakenly taking a product on the same shelf in picking work”, “a scheduled arrival and an actual quantity do not match in night receiving”, “an operation rate of a forklift is decreasing”, “safety confirmation of workers is not thorough”, “an inventory quantity does not match on a specific shelf”, “progress of shipping work is delayed”, “equipment troubles frequently occur”, “a barcode cannot be read”, “a response of an RFID tag is poor”, “a flow line of workers is inefficient”, “there are many mistakes in packing work”, “pallet arrangement is messy and work efficiency is poor”, “break times of workers are biased”, and “education of new workers is insufficient and mistakes frequently occur”. In the case of voice input, voice recognition is performed on the terminal side, and textified contents are transmitted to the server. In the image attachment function, for example, “a state where a shelf label is peeled off”, “a product with a damaged barcode”, “lighting of an abnormal lamp of equipment”, “a congestion status of a work site”, and the like can be transmitted as a photograph, and in the video attachment function, “a state of picking work”, “a flow line during forklift driving”, “a flow of receiving work”, and the like can be recorded and transmitted. In the case of the chatbot format, the worker can also input the issue step by step in accordance with guidance such as “Please tell me what you are having trouble with”. Specifically, the issue input unit functions as a dedicated data collection module expanded on a volatile memory of the terminal. The issue input unit acquires the input natural language text as a character code string in a UTF-8 format. For voice input, the issue input unit extracts an acoustic feature vector including a mel-frequency cepstrum coefficient from a voice waveform using a digital signal processor on the terminal side. The issue input unit inputs the extracted acoustic feature vector to a lightweight recurrent neural network implemented in the terminal. The neural network infers text data from the acoustic feature vector, and outputs character string data. For image input, the issue input unit acquires a two-dimensional array of RGB pixel values from a camera module of the terminal. The issue input unit resizes the acquired two-dimensional array to a predetermined resolution, normalizes each pixel value to a range from 0 to 1, and generates an image tensor. For video input, the issue input unit extracts an image tensor group of a plurality of frames at regular intervals along a time axis. The issue input unit integrates these text data, image tensor, and video tensor, and constructs a multimodal input data set. The issue input unit transmits the constructed input data set to the server via a secure communication protocol. With this configuration, the system can capture a complex situation faced by the on-site worker into a computer with high accuracy and without omission as not only text but also visual and auditory digital data. As a result, the system exhibits a technical effect of dramatically improving accuracy and speed of issue resolution by eliminating an ambiguous report depending on human subjectivity and preventing information omission in subsequent analysis processing. As a specific application field, the system is applicable to a real-time trouble reporting system in a large-scale logistics center and an immediate sharing platform for equipment abnormality in a manufacturing factory.

The input issue information is transmitted from the terminal to the server. On the server side, the generative AI receives issue input contents, and performs keyword extraction, intention analysis, context understanding, image analysis, and video analysis using a natural language processing technology. For example, keywords such as “picking”, “mistake”, “shelf”, “night”, “receiving”, “forklift”, “operation rate”, “safety confirmation”, “inventory”, “shipping”, “equipment trouble”, “barcode”, “RFID”, “flow line”, “packing”, “pallet”, “break”, and “newcomer education” are extracted to grasp a gist and a background of the issue. In the image analysis, “peeling of a shelf label”, “damage of a barcode”, “lighting of an equipment abnormality lamp”, “congestion degree of a work site”, and the like are automatically recognized, and in the video analysis, “deviation from a work procedure”, “dangerous driving of a forklift”, “delay factor of receiving work”, and the like are extracted. When the input contents are ambiguous or information is missing, the generative AI automatically generates an additional question through the interface on the terminal side, and asks the worker for supplementary information such as “on which shelf are there many mistakes?”, “what is the occurrence frequency of the mistake?”, “in which time zone does it occur?”, “in which work procedure does a problem occur?”, “in which equipment does a trouble occur?”, “how is a safety confirmation procedure implemented?”, and “can a site situation be transmitted by an image or a video?”. For example, when the worker inputs “there are many mistakes in picking work”, the generative AI interactively collects information necessary for specifying the issue, such as “what is a shelf number where mistakes frequently occur?”, “is the content of the mistake a product number mistake or a quantity mistake?”, “how is a work environment when the mistake occurs?”, “what is a countermeasure when a similar mistake occurred in the past?”, and “can a site photograph or video when the mistake occurs be transmitted?”. Specifically, the server inputs the received multimodal data to a composite AI model including a large-scale language model and a convolutional neural network. Input data to the composite AI model is a 768-dimensional text tensor obtained by tokenizing text in subword units and converting it into an embedding vector, and a 224 by 224 by 3-dimensional image tensor obtained by resizing and normalizing an image. As a specific example of the input data, the text tensor includes a distributed representation vector of a word such as picking or mistake. The image tensor includes a pixel value array of a damaged barcode. The video tensor includes a time-series image feature amount for 30 frames. The composite AI model calculates a mutual relationship between these tensors using a self-attention mechanism, and performs mapping to a multimodal feature space. The composite AI model outputs a probability distribution vector indicating a category of the issue and a list of extracted keywords as an analysis result. As a specific example of the output data, the probability distribution vector indicates a score of 0.85 for an equipment abnormality category, and indicates a score of 0.12 for a human error category. The keyword list includes character string data such as forklift and operation rate decrease. The server determines whether or not a maximum value of the output probability distribution vector is less than a preset reliability threshold. When determining that the maximum value is less than the threshold, the server regards it as information shortage, and activates an additional question generation module. The additional question generation module specifies a missing feature dimension, and generates a question text for complementing the dimension. The server transmits the generated question text to the terminal. With this configuration, the system reliably converts an ambiguous human report into structured data processable by a computer. As a result, the system exhibits a technical effect of reducing noise in subsequent search processing, improving search accuracy, and reducing unnecessary data communication to reduce a network load. As a specific application field, the system is applicable to an error cause investigation system in automated equipment in a warehouse and a worker support system in a distribution center.

Next, the case search unit is implemented on the server side, and searches a case database dedicated to the logistics center based on the keyword extracted by the generative AI and the attribute information of the worker or the manager (affiliation department, role, shift, assigned area, years of experience, past issue resolution history, work history, education history, assigned equipment, assigned product category, etc.). In the case database, issues that occurred in the past such as a picking mistake, inventory excess/deficiency, receiving delay, equipment trouble, safety management deficiency, work efficiency decrease, shipping delay, inventory mistake, human error of a worker, forklift accident, system failure, barcode reading failure, RFID tag failure, flow line inefficiency, packing mistake, pallet arrangement failure, break time uneven distribution, and newcomer education shortage, and respective solutions, implementation procedures, introduced equipment and systems, persons in charge, occurrence times, effect measurement results, feedback from the site, related manuals and checklists, external vendor information, business flowcharts, internal regulations, education materials, work videos, work photographs, and the like are systematically recorded. The generative AI performs not only simple keyword matching but also semantic similarity calculation, attribute matching, time-series analysis, business process similarity evaluation, past feedback evaluation, similarity of an on-site work environment and equipment configuration, comparison of image/video analysis results, and the like, and preferentially extracts a case closest to the situation of the worker or the manager. For example, case search according to the on-site situation is possible, such as “when a day-shift worker complains of a picking mistake, preferentially presenting a case where a similar issue was resolved in a day-shift zone in the past”, “when a night-shift manager inputs inventory excess/deficiency, prioritizing an automatic inventory introduction case in a night-shift zone”, “for a decrease in forklift operation rate, presenting an equipment maintenance history and an operation log analysis case”, “for thorough safety confirmation, presenting a worker education program and a safety manual revision case”, “for a barcode reading failure, presenting a barcode print quality improvement case and a reader device replacement case”, “for an RFID tag failure, presenting a tag attachment position review case and a reader sensitivity adjustment case”, “for flow line inefficiency, presenting a work flow line optimization simulation case and a layout change case”, “for a packing mistake, presenting a packing procedure manual revision case and an automatic inspection system introduction case”, “for a pallet arrangement failure, presenting a pallet arrangement guideline creation case and an automatic pallet transport robot introduction case”, “for break time uneven distribution, presenting a break scheduler introduction case and a shift adjustment case”, and “for newcomer education shortage, presenting an education program strengthening case and an OJT manual creation case”. Specifically, the case search unit concatenates the extracted keyword group and attribute information, and inputs them to a query vector generation model. Input data to the query vector generation model is heterogeneous mixed data in which text information and numerical information are mixed, and includes, for example, a text feature amount of picking mistake and a numerical feature amount of three years of experience. Specific examples of the input data include a combined tensor of a one-hot vector of an affiliation department code, a normalized numerical value of a shift time, and a word embedding vector of an extracted keyword. The query vector generation model adopts a transformer architecture, and converts the input data into a 1024-dimensional query vector on a high-dimensional latent space and outputs it. The case search unit acquires a vector representation group of past cases stored in advance in the case database. The case search unit calculates a cosine similarity between the query vector and each past case vector. The case search unit executes an approximate nearest neighbor search algorithm based on the calculated cosine similarity. The case search unit outputs an identifier list of past cases having higher similarity scores as a search result. As a specific example of the output data, a scored list in which a case ID 001 has a similarity of 0.92 and a case ID 005 has a similarity of 0.88 is output. The case search unit extracts corresponding case data from the database using the output identifier list. With this configuration, the system specifies a semantically related case that cannot be found by simple character string matching at high speed and accurately by a mathematical operation in a high-dimensional vector space. As a result, the system exhibits a technical effect of dramatically improving search efficiency of the database and deriving an optimal solution while suppressing consumption of calculation resources. As a specific application field, the system is applicable to a maintenance support system that manages a wide variety of trouble histories and an advanced search engine in an internal knowledge sharing platform.

The solution presentation unit is implemented on the server side, and automatically generates a specific solution and an implementation procedure according to the situation of the worker or the manager using the generative AI based on contents of the extracted past case. For example, practical and detailed advice is presented, such as “for reduction of picking mistakes, color coding of shelf labels, introduction of a barcode verification system, re-education for workers, digitization of a picking list, review of a work procedure manual, and construction of an immediate reporting system when a mistake occurs are effective”, “for prevention of inventory excess/deficiency, automation of regular inventory, introduction of an AI inventory prediction system, real-time recording of warehousing/delivery, and construction of a double-check system for inventory work are recommended”, “for resolution of night receiving delay, advance sharing of a scheduled arrival list, introduction of an automatic inspection system, increase in receiving personnel, and standardization of a receiving flow are effective”, “for improvement of forklift operation rate, operation pattern optimization by AI analysis of an operation log, automatic generation of a regular maintenance schedule, driving skill evaluation and re-education of workers, and review of an equipment update plan are effective”, “for thorough safety confirmation, digital checklist conversion of pre-work inspection, distribution of a safety education video, sharing of a near-miss case, and introduction of an automatic detection system for wearing safety equipment are recommended”, “for resolution of barcode reading failure, improvement of barcode print quality, regular inspection/replacement of a reader device, optimization of a barcode attachment position, and firmware update of a barcode reader are effective”, “for resolution of RFID tag failure, review of a tag attachment position, adjustment of reader sensitivity, strengthening of tag quality control, and AI analysis of a tag reading log are effective”, “for resolution of flow line inefficiency, layout optimization by work flow line simulation, zoning of a work area, installation of a flow line guidance sign, and real-time tracking of a worker flow line are effective”, “for reduction of packing mistakes, revision of a packing procedure manual, introduction of an automatic inspection system, educational utilization of a packing work video, and standardization of packing materials are effective”, “for resolution of pallet arrangement failure, creation of a pallet arrangement guideline, introduction of an automatic pallet transport robot, implementation of a pallet arrangement simulation, and image analysis of a pallet arrangement status are effective”, “for resolution of break time uneven distribution, introduction of a break scheduler, shift adjustment, expansion of a break area, and monitoring of a break acquisition status are effective”, and “for resolution of newcomer education shortage, strengthening of an education program, creation of an OJT manual, introduction of an education progress management system, and utilization of an education video are effective”. In addition, contact information to an implementation person in charge of the corresponding case or a related department is automatically guided as necessary so that the worker or the manager can directly receive advice. For example, specific contact information is presented, such as “the person in charge of this case is Suzuki of the logistics management department, and the extension number is 1234”, “the related department is the equipment maintenance department, and the inquiry form is here”, and “the contact information of the project leader who resolved a similar issue in the past can be searched on the internal SNS”. Specifically, the solution presentation unit integrates the text data of the extracted past case and the current issue input data, and inputs them to a sequence conversion model. Input data to the sequence conversion model is a combined tensor of a token sequence indicating a resolution procedure of the past case and a context vector indicating a current on-site situation. Specific examples of the input data include a text vector indicating a past barcode reader replacement procedure and a numerical vector indicating a skill level of a current worker. The sequence conversion model includes an encoder-decoder architecture, encodes the input tensor into a latent representation, and then autoregressively generates a new solution text using a decoder. The sequence conversion model applies a beam search algorithm in a generation process, and selects a word sequence having the highest generation probability. The sequence conversion model outputs structured text data indicating a specific implementation procedure and metadata including related contact information as an output. As a specific example of the output data, step-by-step text data such as confirmation of a shelf label as procedure 1 and system restart as procedure 2, and metadata in a JSON format including a person-in-charge ID and an extension number are output. The solution presentation unit performs format conversion on the output structured text data in accordance with a display format of the terminal. The solution presentation unit transmits the format-converted data to the terminal. With this configuration, the system dynamically reconstructs past static case data in accordance with a current dynamic situation, and presents it as a specific procedure that can be immediately executed by a human. As a result, the system exhibits a technical effect of significantly reducing time for the worker to consider a solution and minimizing business downtime. As a specific application field, the system is applicable to an operator support system in a call center and a work procedure automatic generation system for field engineers.

Furthermore, the solution presentation unit can also compare and present a plurality of solutions. For example, the generative AI automatically organizes merits/demerits, costs, introduction periods, risks, the number of past success cases, and the like for each option, such as “Plan A: introduction of barcode verification system, Plan B: digitization of picking list, Plan C: re-education of workers”, and supports the worker or the manager to select an optimal solution. Furthermore, a reference document, template, checklist, FAQ, related law, external vendor information, education video, work photograph, and the like are automatically linked and presented for each solution. Specifically, the solution presentation unit inputs a plurality of generated solution candidates to an evaluation module. Input data to the evaluation module is a text vector of each solution candidate and a numerical matrix indicating a cost and a period in a past similar case. Specific examples of the input data include a text vector of Plan A, a scalar value indicating an introduction cost, and a floating-point number indicating a success probability. The evaluation module calculates a comprehensive evaluation score of each solution candidate using a multilayer perceptron. The evaluation module outputs a multidimensional evaluation vector including an evaluation score, a cost prediction value, and a risk probability of each solution as an output. As a specific example of the output data, numerical data of a comprehensive score of 0.9, a cost prediction value of 500,000 yen, and a risk probability of 0.1 for Plan A is output. The solution presentation unit converts the plurality of solutions into structured data in a comparison table format based on the output evaluation vector. The solution presentation unit acquires a URI of a document or a path of a video file related to each solution from the database, and adds it to the structured data as link information. The solution presentation unit transmits the structured data to which the link information is added to the terminal. With this configuration, the system automatically calculates an objective and quantitative evaluation index for a plurality of options, and supports a human decision-making process based on a mathematical basis. As a result, the system exhibits a technical effect of improving selection accuracy of an optimal solution and reducing wasteful resource consumption of a computer and a network required for information collection. As a specific application field, the system is applicable to an investment decision support system for the management layer and a risk evaluation tool in project management.

The execution support unit is implemented on the server side, automatically breaks down and generates a task necessary for executing the solution presented by the generative AI, and registers the task in cooperation with a task management tool via an API. For example, a plurality of tasks are automatically generated in chronological order, such as “implementation of shelf label color coding work”, “installation of barcode verification system”, “holding of operation briefing session for workers”, “recording of number of mistake occurrences for effect measurement”, “introduction of regular inventory automation system”, “setting of AI inventory prediction system”, “arrangement of increase in night receiving personnel”, “collection and analysis of forklift operation log”, “creation of distribution schedule of safety education video”, “firmware update of barcode reader”, “review of RFID tag attachment position”, “implementation of work flow line simulation”, “revision of packing procedure manual”, “creation of pallet arrangement guideline”, “introduction of break scheduler”, and “progress management of education program”, and are reflected on a task management screen of the worker or the manager. A progress status of the task can be updated by the worker or the manager from the terminal, and progress information is aggregated in the server. When progress is delayed or a task delay occurs, the generative AI can also automatically generate a reminder notification or additional advice, and push-notify it to the terminal side. For example, a specific action according to the progress is prompted, such as “shelf label color coding work is delayed by one week. Assignment of an additional worker is proposed”, “progress of barcode verification system installation is unstarted. Do you want to send a reminder to the person in charge?”, “participation rate of worker briefing session is decreasing. Holding of an additional briefing session is proposed”, “RFID tag attachment position review work is not progressing. Retransmission of a site photograph is requested”, “result of flow line simulation is unsubmitted. Automatic report generation of simulation result is proposed”, and “progress of packing procedure manual revision is delayed. Past revision case is re-presented”. Specifically, the execution support unit inputs the text data of the selected solution to a task breakdown model. Input data to the task breakdown model is a text vector indicating an overall procedure of the solution and a parameter array indicating a constraint condition of target equipment or personnel. Specific examples of the input data include a text vector of barcode verification system introduction, a timestamp indicating an introduction deadline, and numerical data indicating an available budget. The task breakdown model extracts a pair of a specific action verb and a target noun from the text vector using dependency parsing and a named entity extraction algorithm. The task breakdown model generates a directed acyclic graph indicating a dependency relationship between tasks based on the extracted pair. The task breakdown model outputs an array of task objects including a name, a person-in-charge ID, a scheduled start date and time, a scheduled end date and time, and a preceding task ID of each task as an output. As a specific example of the output data, a data structure of a task ID 001, a name equipment ordering, a person-in-charge ID 123, and a deadline Oct. 1, 2023 is output. The execution support unit transmits the output array of task objects to an external task management database via a REST-format API, and registers it as a record. The execution support unit periodically polls the task management database, and acquires a progress status of each task. The execution support unit compares a current time and the scheduled end date and time, and determines a delay flag. When the delay flag is true, the execution support unit activates a reminder generation module, and generates a notification text including inference of a delay reason and an alternative plan. The execution support unit push-transmits the generated notification text to a terminal of a target person. With this configuration, the system converts an abstract solution into a minimum unit data structure trackable by a computer, and automatically monitors and controls an execution process. As a result, the system exhibits a technical effect of dramatically improving business efficiency by preventing execution omission of a task and minimizing progress delay of the entire project. As a specific application field, the system is applicable to an agile development management tool in software development and a process management system in a large-scale construction project.

The effect measurement unit is implemented on the server side, collects an execution result of the task and feedback from the worker/manager, and measures a quantitative and qualitative effect. For example, a quantitative effect index is automatically aggregated, such as “picking mistakes decreased from a monthly average of 10 to 3”, “inventory accuracy improved from 95% to 99%”, “night receiving delay was resolved”, “forklift operation rate improved from 80% to 95%”, “implementation rate of safety confirmation improved”, “satisfaction degree of workers improved”, “barcode reading failure was halved”, “RFID tag failure was resolved”, “work time was shortened by 20% by flow line optimization”, “packing mistakes decreased by 70%”, “work efficiency improved by 15% by optimization of pallet arrangement”, “uneven distribution of break times was resolved and fatigue degree of workers was reduced”, and “mistake rate of newcomers was halved by strengthening newcomer education program”. In addition, qualitative feedback is also collected, such as “on-site adjustment faced difficulty at the time of introduction”, “there was an unclear point in an operation method of a new system”, “there was a backlash from workers”, “equipment troubles temporarily increased”, “viewing rate of education video is low”, “congestion of work site is not resolved”, and “congestion of break area continues”, and the generative AI automatically performs text mining and emotion analysis. For example, when the worker inputs “a new barcode system is convenient, but initial setting work took time”, the generative AI extracts an improvement point such as “strengthening of support system for initial setting is necessary”. Specifically, the effect measurement unit inputs quantitative data acquired from a business system and a qualitative feedback text collected from the terminal to an integrated analysis model. Input data to the integrated analysis model is a time-series numerical array indicating the number of error occurrences before and after task execution and an embedding vector of a natural language text input by the worker. Specific examples of the input data include a one-dimensional array indicating the number of picking mistakes in the past 30 days and a 768-dimensional vector obtained by converting a text that setting work took time. The integrated analysis model statistically tests a trend change using an autoregressive moving average model for the quantitative data, and calculates an emotion polarity score using a bidirectional transformer encoder for the qualitative data. The integrated analysis model outputs a percentage value indicating an improvement effect, a continuous value from minus one to plus one indicating emotion polarity, and a keyword list of an extracted improvement request as an output. As a specific example of the output data, a numerical value of a mistake decrease rate of 70 percent, a numerical value of an emotion score of minus 0.3, and a keyword of initial setting support are output. The effect measurement unit determines whether or not the output numerical data has reached a preset target threshold. When the target threshold is not reached, the effect measurement unit transmits the extracted keyword list to the continuous improvement unit. With this configuration, the system integrally performs arithmetic processing on heterogeneous data of quantitative data easy to quantify and human emotions and opinions difficult to quantify on the same evaluation infrastructure. As a result, the system exhibits a technical effect that a computer can objectively quantify not only a mere increase/decrease in numerical values but also a true issue or dissatisfaction on site, and utilize it as a trigger for a next improvement action. As a specific application field, the system is applicable to an automatic aggregation/analysis system for a customer satisfaction survey and a market reaction monitoring platform after introduction of a new product.

The continuous improvement unit is implemented on the server side, and the generative AI analyzes the issue resolution status of all sites, the past case, and the feedback information obtained by the effect measurement unit chronologically and by attribute, and extracts a tendency and a potential risk of the entire logistics center. For example, it extracts a tendency and a risk of the entire organization, such as “a tendency that picking mistakes frequently occur in a day shift”, “a tendency that inventory excess and deficiency increase in a night shift”, “a tendency that equipment troubles are concentrated in a specific area”, “a period when an implementation rate of safety confirmation decreases”, “shipping delays are concentrated on a specific day of the week”, “barcode reading failures frequently occur in a specific product category”, “RFID tag failures occur in a specific lot”, “flow line inefficiency is remarkable in a newly established area”, “packing mistakes increase in a busy season”, “pallet arrangement failures are common among new workers”, “uneven distribution of break times occurs in a specific shift”, and “lack of new employee education is concentrated on new hires”. Based on these analysis results, the generative AI automatically generates an improvement proposal and a risk preventive measure for the management layer or the management department, such as “company-wide deployment of picking work standardization”, “introduction of an AI inventory prediction system to all bases”, “review of an equipment maintenance cycle”, “enhancement of a safety education program”, “redesign of a shipping work flow”, “thoroughness of barcode print quality management”, “enhancement of RFID tag quality management”, “deployment of flow line optimization simulation to all areas”, “standardization of a packing procedure manual”, “deployment of a pallet arrangement guideline to all sites”, “introduction of a break scheduler to all shifts”, and “application of an education program to all new hires”, and realizes continuous business improvement and knowledge aggregation of the entire organization. Specifically, the continuous improvement unit inputs log data of all bases accumulated in a database to a time-series prediction model and a clustering algorithm. Input data to the time-series prediction model is a multidimensional time-series tensor including attribute information of each base, a time zone index, and an error occurrence frequency. As a specific example of the input data, a base ID, a categorical variable indicating a shift classification, and a daily error count array for the past six months are included. The time-series prediction model learns hidden periodicity and a trend of time-series data using a long short-term memory network. The clustering algorithm groups bases having similar error occurrence patterns on a multidimensional feature space using a K-means method. The continuous improvement unit outputs a prediction score array indicating a future error occurrence probability and a feature importance vector indicating a risk factor as an output. As a specific example of the output data, a predicted value of an 85% probability of occurrence of inventory excess and deficiency in the night shift of next month and a weighting coefficient indicating that a new employee ratio is the most important risk factor are output. When the output prediction score exceeds a warning threshold, the continuous improvement unit activates a risk preventive measure generation module. The risk preventive measure generation module generates text data of the most effective improvement measure based on the feature importance vector. The continuous improvement unit transmits the generated text data to a dashboard screen of the management layer. With this configuration, the system predicts a complex correlation and a future risk that a human cannot intuitively grasp from a huge amount of log data with high accuracy using a mathematical model. As a result, the system enables proactive business management in which a measure is taken before a problem occurs, and exhibits a technical effect of significantly reducing an operation cost of the entire organization. As a specific application field, the system is applicable to a yield prediction system in a large-scale manufacturing industry and a sign detection system for an unauthorized transaction in a financial institution.

Furthermore, for example, even when an on-site worker voluntarily posts a case solved in the past, the generative AI automatically performs summarization, classification, tagging, and association with a similar case of posted contents, and contributes to quality improvement of the knowledge base. For example, “when a case in which a nighttime cargo receipt delay is resolved is posted, the generative AI automatically assigns tags such as ‘nighttime’, ‘cargo receipt’, ‘delay’, and ‘automatic inspection’, and links it with a related past case”. In addition, when a plurality of workers input the same business issue at the same time, the generative AI can automatically group them and present a solution collectively as a common issue. For example, “when an issue of ‘picking mistake’ occurs simultaneously in a plurality of areas, the generative AI proposes a company-wide countermeasure and cross-sectionally manages a progress status of each area”. Specifically, the continuous improvement unit inputs a newly posted text transmitted from a terminal to a natural language processing pipeline. Input data to the natural language processing pipeline is unstructured text data freely described by the worker. As a specific example of the input data, a character string indicating that a delay was resolved when a handy terminal was restarted during nighttime cargo receipt is included. The natural language processing pipeline extracts an important sentence from the text using a pre-trained language model, and generates a summary text. The natural language processing pipeline extracts a word vector serving as a tag candidate from the text using a named entity extraction model. The natural language processing pipeline outputs the summary text, a list of assigned tags, and a similarity score matrix with an existing case as an output. As a specific example of the output data, a summary sentence of delay resolution by handy terminal restart, a tag list of nighttime and equipment trouble, and a numerical value of a similarity of 0.95 with an existing case ID 003 are output. When there is an existing case in which the output similarity score exceeds a predetermined threshold, the continuous improvement unit generates a bidirectional link pointer between both records on the database. When a plurality of new posts having a high similarity score are detected within a certain period, the continuous improvement unit executes a clustering process to integrate them into one common issue group. The continuous improvement unit generates an alert notification for the entire company for the integrated common issue group, and transmits it to a manager terminal. With this configuration, the system automatically structures unstructured data accumulated daily, and continuously improves searchability and exhaustiveness of the database. As a result, the system exhibits a technical effect of reducing a human cost required for maintenance of the knowledge base and preventing information silos. As a specific application field, the system is applicable to an FAQ automatic generation system of an internal help desk and an integrated management system of an incident report in a medical institution.

In addition, even when a person in charge or business contents are changed due to organizational restructuring, personnel reassignment, or the like, the generative AI automatically updates worker attribute information so that optimal case search and solution presentation are continued. For example, it is also possible to cooperate with an external business system or groupware to acquire and reflect the latest organizational information and business process information in real time. For example, it flexibly responds to an organizational change, such as “a worker who is newly in charge of a night shift due to personnel reassignment can immediately refer to a past night shift case” and “a past similar area case is automatically recommended for a newly established area”. Specifically, the continuous improvement unit periodically receives organizational change data from an external personnel management system, and inputs it to an attribute update module. Input data to the attribute update module is structured data in a CSV format or a JSON format including an employee ID, an affiliation code before change, an affiliation code after change, and a transfer date. As a specific example of the input data, a record indicating that an employee ID 999 has been transferred from a day shift department to a night shift department is included. The attribute update module updates a corresponding record of a worker attribute table in the database based on the received data. The attribute update module recalculates a feature vector of a recommendation engine for the worker using the updated attribute information. The attribute update module outputs an ID list of a new recommended case based on the updated feature vector as an output. As a specific example of the output data, an ID list indicating a troubleshooting case in the night shift is output. The continuous improvement unit dynamically rewrites contents displayed on a dashboard screen of the terminal of the worker based on the output ID list. With this configuration, the system automatically optimizes a parameter inside the system following a dynamic change of the organization, and always maintains information provision based on the latest context. As a result, the system exhibits a technical effect of reducing an education cost for a worker immediately after transfer and shortening a start-up time of business. As a specific application field, the system is applicable to a personalized internal portal site in a large-scale enterprise and an access control system in which authority dynamically fluctuates.

Furthermore, for example, when cooperation with an external vendor or a consultant is necessary, the generative AI extracts a past external cooperation case, and specifically presents a vendor selection criterion, a point of contract negotiation, a note at the time of outsourcing, and the like. For example, know-how of external resource utilization such as “an external vendor selection case at the time of equipment introduction” and “a risk management case at the time of an outsourcing contract” can also be systematically utilized. Specifically, when it is determined that an external resource is necessary in execution of the solution, the continuous improvement unit activates a vendor cooperation support module. Input data to the vendor cooperation support module is a text vector indicating a required technical requirement and matrix data including a past vendor evaluation score. As a specific example of the input data, a technical requirement vector of introduction of an automatic transfer robot and numerical data indicating a past delivery date compliance rate and cost performance are included. The vendor cooperation support module extracts related past contract data and an evaluation report from the database using an information retrieval algorithm. The vendor cooperation support module inputs the extracted text data to a summarization model, and extracts an important negotiation point and a risk factor. The vendor cooperation support module outputs structured data including a list of recommended vendors, an evaluation score of each vendor, and a checklist to be confirmed at the time of contract as an output. As a specific example of the output data, text data indicating that a vendor company A has a score of 95 points and a response time of maintenance support as a confirmation item is output. The continuous improvement unit generates and transmits HTML data for displaying the output structured data on a screen of the manager terminal. With this configuration, the system optimizes not only internal technical issue resolution but also a procurement process of an external resource in a data-driven manner. As a result, the system exhibits a technical effect of ensuring objectivity of vendor selection and reducing a risk of a contract trouble. As a specific application field, the system is applicable to a supplier evaluation system in a purchasing department and a contract review support system in a legal department.

As described above, the embodiment of the present invention realizes automation and optimization of the entire issue resolution process in the logistics center, aggregation and utilization of personalized know-how, business efficiency improvement, and continuous evolution of organizational knowledge while clarifying role sharing between the server and the terminal with the generative AI as an essential core technology. Main processing of each unit is realized on the server side, and the terminal side mainly bears a user interface and an input assistance function, notification reception, progress input, voice/image/video input, and the like. The generative AI is utilized one by one in all scenes of the entire system, such as natural language understanding, image/video analysis, semantic search, task automatic generation, effect analysis, cross-organizational knowledge extraction/report generation, summarization/classification/tagging of posted contents, grouping, and external system cooperation. Thereby, it becomes a logistics center business optimization system that realizes total optimization and continuous business innovation involving from an on-site worker to a manager and a management layer. Specifically, the system adopts a client-server architecture in which lightweight data collection processing on the terminal side and heavy parallel arithmetic processing on the server side are separated. The system arranges an arithmetic cluster equipped with a plurality of graphics processing units on the server side. The arithmetic cluster executes inference processing using a deep learning model of a scale of billions of parameters in parallel on input multimodal data. Input data to the arithmetic cluster is stream data of text, voice, image, and video asynchronously transmitted from the terminal. As a specific example of the input data, hundreds of issue report data per second transmitted simultaneously from a plurality of terminals are included. The arithmetic cluster processes these data in real time, and pipelines tensor data between respective modules. The arithmetic cluster outputs an integrated control signal including an optimized solution, a generated task list, and an analysis report as an output. As a specific example of the output data, a JSON payload for updating a screen display of each terminal and an API request for controlling an external system are output. The system routes the output control signal to each terminal and the external system. With this configuration, the system realizes optimization of distributed processing in which advanced AI processing requiring a huge amount of computational resources is aggregated on the server side while responsiveness on the terminal side is maintained. As a result, the system exhibits a technical effect of maximizing processing throughput of the entire system and providing real-time decision-making support without delay even in a large-scale organization. As a specific application field, the system is applicable to an integrated business management platform of a multinational enterprise expanding globally and an infrastructure monitoring/control system in a smart city.

### System Configuration

The system according to the present embodiment includes an issue input unit, an information complementation unit, a case search unit, a solution presentation unit, an execution support unit, an effect measurement unit, a continuous improvement unit, a user interface unit, a database management unit, and an external cooperation unit. The issue input unit has a function for an on-site worker or a manager of a logistics center to input a business issue faced during daily business in a natural language, includes a text input field, a voice input function, a chatbot-format interactive UI, an image attachment function, a video attachment function, and the like, and can input a specific issue occurring on site as it is, such as “often mistakenly taking a product on the same shelf in picking work”, “an arrival schedule and an actual quantity do not match in nighttime cargo receipt”, “an operation rate of a forklift is decreasing”, “safety confirmation of a worker is not thorough”, “a barcode cannot be read”, “a response of an RFID tag is poor”, “many mistakes in packing work”, “pallet arrangement is messy and work efficiency is poor”, and “education of a new worker is insufficient and mistakes frequently occur”. When contents transmitted from the issue input unit are ambiguous or information is missing, the information complementation unit automatically generates an additional question using generative AI, such as “on which shelf are there many mistakes?”, “what is a frequency of occurrence of the mistake?”, “in which time zone does it occur?”, “can a situation of the site be transmitted by an image or a video?”, “how is a work environment when the mistake occurs?”, and “what is a countermeasure when a similar mistake occurred in the past?”, and interactively collects supplementary information. As a specific example of a prompt sentence, “generate an additional question necessary for clarifying details and a background of an issue, a related business process, an occurrence frequency, involved equipment, an on-site situation image, a video, and the like based on input issue contents” is cited. Specifically, the information complementation unit inputs initial input data received from the issue input unit to an intention interpretation model. Input data to the intention interpretation model is a tensor obtained by vectorizing a natural language text and a pixel feature amount array of an attached image. As a specific example of the input data, an embedding vector of a text indicating that a barcode cannot be read and a tensor of an out-of-focus barcode image are included. The intention interpretation model calculates information entropy of the input tensor, and specifies a dimension in which an information amount is less than a predetermined threshold. The information complementation unit dynamically constructs a prompt character string for complementing the specified missing dimension, and inputs it to a large language model. The large language model outputs an additional question text to be presented to a user and metadata indicating a data type of an expected answer as an output. As a specific example of the output data, a text asking to tell a model name of a reader and a flag indicating that an answer type is a character string are output. The information complementation unit transmits the output additional question text to the terminal, and waits for a response from the user. With this configuration, the system autonomously activates an information collection process for incomplete input data, and ensures data quality necessary for subsequent processing. As a result, the system exhibits a technical effect of preventing interruption of processing due to an error and improving robustness of the entire system. As a specific application field, the system is applicable to an automatic response type customer support bot and a preliminary information collection system in a medical interview.

The case search unit has a function of searching a case database dedicated to the logistics center based on a keyword extracted using the generative AI and attribute information of the worker or the manager (affiliation department, role, shift, assigned area, years of experience, past issue resolution history, work history, education history, assigned equipment, assigned product category, etc.), and enables case search according to an on-site situation, such as “when a day shift worker complains of a picking mistake, a case in which a similar issue was solved in a day shift in the past is preferentially presented”, “when a night shift manager inputs inventory excess and deficiency, an automatic inventory introduction case in a night shift is prioritized”, “for a decrease in an operation rate of a forklift, an equipment maintenance history and an operation log analysis case are presented”, “for a barcode reading failure, a barcode print quality improvement case and a reader equipment replacement case are presented”, “for an RFID tag failure, a tag attachment position review case and a reader sensitivity adjustment case are presented”, “for flow line inefficiency, a work flow line optimization simulation case and a layout change case are presented”, “for a packing mistake, a packing procedure manual revision case and an automatic inspection system introduction case are presented”, “for a pallet arrangement failure, a pallet arrangement guideline creation case and an automatic pallet transfer robot introduction case are presented”, and “for lack of new employee education, an education program enhancement case and an OJT manual creation case are presented”. As a specific example of a prompt sentence, “extract a past case having the highest relevance from a logistics center case database based on given issue contents and worker attribute information, and list them in descending order of similarity” is cited. Specifically, the case search unit combines the extracted keyword vector and the attribute information vector to generate a multidimensional search query tensor. Input data to the case search unit is a query tensor indicating a current issue situation and a group of tens of thousands of past case vectors stored in the database. As a specific example of the input data, the query tensor is a combination of a vector indicating an event of a picking mistake and a vector indicating an attribute of less than one year of experience. The case search unit calculates a similarity distance between the query tensor and all past case vectors at high speed using a vector search engine optimized for inner product calculation. The case search unit outputs an ID array of past cases sorted in ascending order of similarity distance and a similarity score of each case as an output. As a specific example of the output data, a case ID array and numerical data in which respective scores are 0.95, 0.91, and 0.88 are output. The case search unit acquires a detailed case text and a related image from the database based on the output ID array, and transfers them to the solution presentation unit. With this configuration, the system realizes advanced semantic search considering a subtle nuance of a context or an attribute, which is impossible by conditional search of a simple relational database. As a result, the system exhibits a technical effect of simultaneously improving precision and recall of search and shortening an arrival time to information desired by a user to the utmost limit. As a specific application field, the system is applicable to a similar search system of patent documents and a past similar case search system in an electronic medical record.

The solution presentation unit has a function of automatically generating a specific solution and an implementation procedure according to a situation of the worker or the manager using the generative AI based on contents of the past case extracted by the case search unit, presents practical and detailed advice, such as “for reduction of picking mistakes, color coding of shelf labels, introduction of a barcode verification system, re-education for workers, digitization of a picking list, review of a work procedure manual, and construction of an immediate reporting system at the time of mistake occurrence are effective”, “for prevention of inventory excess and deficiency, automation of regular inventory, introduction of an AI inventory prediction system, real-time recording of warehousing and delivery, and construction of a double check system for inventory work are recommended”, “for resolution of nighttime cargo receipt delay, advance sharing of an arrival schedule list, introduction of an automatic inspection system, increase in cargo receipt personnel, and standardization of a cargo receipt flow are effective”, “for improvement of a forklift operation rate, operation pattern optimization by AI analysis of an operation log, automatic generation of a regular maintenance schedule, driving skill evaluation and re-education of a worker, and review of an equipment update plan are effective”, and “for thoroughness of safety confirmation, digital checklist conversion of pre-work inspection, distribution of a safety education video, sharing of a near-miss case, and introduction of an automatic detection system for wearing safety equipment are recommended”, automatically guides contact information to an implementation person in charge of the corresponding case or a related department as necessary, and presents specific contact information, such as “a person in charge of this case is Suzuki of a logistics management department, and an extension number is 1234”, “a related department is an equipment maintenance department, and an inquiry form is here”, and “contact information of a project leader who solved a similar issue in the past can be searched on an internal SNS”. As a specific example of a prompt sentence, “exhaustively generate an optimal solution, its implementation procedure, a note, a reference material, and contact information based on contents of an extracted past case and a current situation of a worker” is cited. Specifically, the solution presentation unit integrates the past case text transferred from the case search unit and a current issue context, and inputs them to a text generation model. Input data to the text generation model is a text sequence of a past success case and a parameter vector indicating a current constraint condition. As a specific example of the input data, a text indicating a past shelf label color coding procedure and numerical data indicating a current budget upper limit are included. The text generation model autoregressively generates a text sequence of a new solution most suitable for the input context using a decoder block of a transformer. The solution presentation unit outputs text data in a markdown format indicating a step-by-step implementation procedure and a JSON object including related contact information as an output. As a specific example of the output data, bulleted text of procedure 1 and procedure 2 and structured data including a name of a person in charge and an email address are output. The solution presentation unit combines the output text data and the JSON object, and generates and transmits a display payload of the terminal. With this configuration, the system does not present past static information as it is, but generates an executable procedure manual dynamically customized according to a current situation in real time. As a result, the system exhibits a technical effect of reducing a human cognitive load required for digestion and application of information and enabling an action for issue resolution to be immediately started. As a specific application field, the system is applicable to a failure recovery procedure automatic generation system of an IT infrastructure and a dynamic generation system of an evacuation guidance plan at the time of a disaster.

The execution support unit has a function of automatically breaking down and generating a task necessary for executing the solution presented by the solution presentation unit using the generative AI, and registering the task in cooperation with a task management tool via an API, automatically generates a plurality of tasks in chronological order, such as “implementation of shelf label color coding work”, “installation of a barcode verification system”, “holding of an operation briefing session for workers”, “recording of the number of mistake occurrences for effect measurement”, “introduction of a regular inventory automation system”, “setting of an AI inventory prediction system”, “arrangement of an increase in nighttime cargo receipt personnel”, “collection and analysis of a forklift operation log”, and “creation of a distribution schedule of a safety education video”, reflects them on a task management screen of the worker or the manager, and when progress is delayed or a task delay occurs, automatically generates a reminder notification or additional advice, and prompts a specific action according to the progress, such as “shelf label color coding work is delayed by one week. We propose assignment of an additional worker” and “progress of barcode verification system installation is unstarted. Do you want to send a reminder to a person in charge?”. As a specific example of a prompt sentence, “break down a task necessary for executing a presented solution, and generate contents, a person in charge, a deadline, a progress management method, and reminder notification contents of each task” is cited. Specifically, the execution support unit inputs text data of the generated solution to a task extraction model. Input data to the task extraction model is a text vector indicating an overall procedure of the solution. As a specific example of the input data, a vector including a character string of installation of a barcode verification system and holding of an operation briefing session is included. The task extraction model specifies an action verb and a target noun in the text using a sequence labeling algorithm, and constructs a dependency graph of tasks. The execution support unit outputs an array of task objects including attribute information of each task as an output. As a specific example of the output data, a JSON array including a task name, a person in charge ID, a scheduled start date, a scheduled end date, and a status flag is output. The execution support unit transmits the output JSON array to an API endpoint of an external task management system using a POST method of HTTP. The execution support unit periodically acquires a status flag of the task via the API, and compares it with a current time to detect a delay. When detecting a delay, the execution support unit generates a warning text using a reminder generation model, and transmits a push notification to a terminal of a target person. With this configuration, the system converts a plan described in a natural language into structured data whose execution can be managed by a computer, and automates progress management. As a result, the system exhibits a technical effect of significantly reducing a burden on a project manager and preventing execution omission or delay of a task at a system level. As a specific application field, the system is applicable to a progress management system of a marketing campaign and a task automatic generation/management platform at the time of launching a new store.

The effect measurement unit has a function of collecting an execution result of the task managed by the execution support unit and feedback from a worker or a manager, and measuring a quantitative and qualitative effect using generative AI, automatically aggregates a quantitative effect index such as “picking mistakes decreased from an average of 10 to 3 per month”, “inventory accuracy improved from 95% to 99%”, “nighttime cargo receipt delay was resolved”, “forklift operation rate improved from 80% to 95%”, “implementation rate of safety confirmation improved”, and “worker satisfaction improved”, also collects qualitative feedback such as “on-site adjustment was difficult at the time of introduction”, “there was an unclear point in an operation method of a new system”, “there was a backlash from workers”, and “equipment trouble temporarily increased”, and the generative AI automatically performs text mining and sentiment analysis to extract an improvement point such as “a new barcode system is convenient, but initial setting work took time”. A specific example of a prompt sentence includes “extract a quantitative effect index and a qualitative improvement point based on a task execution result and worker feedback, and generate an effect measurement report”. Specifically, the effect measurement unit inputs quantitative performance index data extracted from a business database and a qualitative feedback text collected from a terminal into an integrated evaluation model. Input data to the integrated evaluation model is a time-series tensor indicating a numerical change before and after task execution, and an embedding vector of a natural language text. Specific examples of the input data include a one-dimensional array indicating a transition of the number of mistake occurrences, and a multidimensional vector obtained by converting a text that the setting work took time. The integrated evaluation model executes a statistical hypothesis test on quantitative data to calculate a significant difference, and calculates a polarity score on qualitative data using a pre-trained sentiment analysis model. The effect measurement unit outputs, as an output, a percentage value indicating a quantitative improvement rate, a qualitative sentiment score, and a list of extracted issue keywords. As specific examples of output data, an improvement rate of 70 percent, a sentiment score of minus 0.2, and a keyword of initial setting are output. The effect measurement unit integrates these output data to generate effect measurement report data including a dataset for visual graph drawing. The effect measurement unit transmits the generated report data to a manager terminal. With this configuration, the system integrally analyzes information of different modalities, which are numerical data and text data, and evaluates true effectiveness of a measure from multiple angles. As a result, the system exhibits a technical effect of not only simply improving numerical values but also discovering a feeling of burden on site and a new issue at an early stage, and quickly connecting to a next improvement cycle. As a specific application field, the system is applicable to an automatic aggregation/analysis system for multifaceted evaluation in personnel evaluation, and a user review integrated analysis platform after a product update.

The continuous improvement unit analyzes an issue resolution status of all sites, a past case, and feedback information obtained by the effect measurement unit chronologically and by attribute by generative AI, extracts a tendency and a potential risk of an entire logistics center, extracts a tendency and a risk of an entire organization such as “a tendency that picking mistakes frequently occur in a day shift”, “a tendency that inventory excess/deficiency increases in a night shift”, “a tendency that equipment troubles are concentrated in a specific area”, and “there is a period when an implementation rate of safety confirmation decreases”, automatically generates a business improvement proposal and a risk preventive measure to a management layer or a management department such as “company-wide deployment of picking work standardization”, “all-base introduction of an AI inventory prediction system”, “review of an equipment maintenance cycle”, and “enhancement of a safety education program” based on these analysis results, and realizes continuous business improvement and knowledge aggregation of the entire organization. A specific example of a prompt sentence includes “analyze an issue resolution status and feedback of all sites chronologically and by attribute, extract a tendency of an entire logistics center, a recurrence risk, a proactive prevention measure, and a business improvement proposal, and generate a report for a management layer”. Specifically, the continuous improvement unit inputs a large-scale dataset integrating effect measurement data and log data of all bases into a deep learning-based anomaly detection model and trend prediction model. Input data to the model is a multidimensional time-series tensor including a base ID, a time zone, an error type, and an occurrence frequency. Specific examples of the input data include an error occurrence number matrix by time zone at each base for the past one month. The model learns a normal operation pattern using an autoencoder, and extracts a potential risk by calculating a reconstruction error between the input data and reconstructed data. The continuous improvement unit outputs, as an output, heatmap data indicating a future risk occurrence probability, and text data of a recommended company-wide measure. As specific examples of output data, numerical data of an equipment trouble occurrence probability of 80 percent in a specific area and text data of a maintenance cycle review are output. The continuous improvement unit converts the output data into a structured report format for display on a dashboard for the management layer, and transmits the converted data. With this configuration, the system mathematically derives a macro organizational issue from an accumulation of local events, and supports data-driven management judgment. As a result, the system exhibits a technical effect of accelerating strategic decision-making toward optimization of the entire organization without depending on a personalized rule of thumb. As a specific application field, the system is applicable to an analysis system for a company-wide sales slump factor in a retail business developing multiple stores, and a medical accident proactive prevention platform in a large-scale hospital group.

A user interface unit provides a screen and an operation system for an on-site worker or a manager to perform issue input, solution browsing, task progress input, feedback transmission, notification reception, and the like, includes, for example, an issue input screen, a solution presentation screen, a task management screen, an effect measurement screen, a feedback input screen, a notification popup, and the like, and generative AI can also automatically adjust an optimal screen configuration and input assistance based on an operation history and a usage tendency of the worker. Specifically, the user interface unit functions as a rendering engine that controls a group of graphical components drawn on a display of a terminal. Input data to the user interface unit is a time-series vector of an operation log including a user's screen touch coordinates, a scroll amount, a stay time, and an input keystroke. Specific examples of the input data include numerical data indicating that a stay time in a specific input field exceeds 10 seconds, and coordinate data of a frequently clicked button. The user interface unit inputs these operation log vectors into a reinforcement learning model, and infers a user's intention and proficiency level. The reinforcement learning model outputs an optimization parameter of a screen layout and a candidate list of input suggestions based on an inference result. As specific examples of output data, layout change instruction data for moving a button of a frequently used function to an upper part of the screen, and a character string list of autocomplete to be displayed in an input field are output. The user interface unit dynamically reconstructs a DOM tree based on the output parameter, and updates a screen display in real time. With this configuration, the system provides not a static screen design but a dynamic interface that self-evolves by adapting to individual characteristics and situations of a user. As a result, the system exhibits a technical effect of shortening an overall task completion time by minimizing a user's input load and reducing an operation mistake of the system. As a specific application field, the system is applicable to a personalized healthcare application for elderly people, and a control panel of an industrial machine involving a complex operation.

A database management unit centrally manages data of an entire system such as a case database, a task management database, an effect measurement database, a worker attribute database, and a feedback database, performs registration/update/deletion of a past case, recording of task progress, aggregation of effect measurement data, management of worker information, accumulation of feedback, storage of external cooperation data, and the like, and generative AI automatically executes data quality check, deduplication, tagging, classification, summarization, association, and the like to optimize the database. Specifically, the database management unit controls a hybrid configuration of a relational database and a vector database constructed on a distributed storage system. Input data to the database management unit is transaction data including an insertion request, an update request, and a deletion request of a new record asynchronously transmitted from each module. Specific examples of the input data include a JSON payload including text data, an image tensor, and metadata of a newly resolved issue. The database management unit inputs the input text data into a natural language processing model, and generates a semantic vector representation. The database management unit calculates a cosine similarity between the generated vector representation and a vector representation of an existing record, and detects a duplicate record whose similarity exceeds a predetermined threshold. The database management unit outputs, as an output, a deduplicated clean dataset, an automatically assigned index tag, and graph structure data indicating a relationship between records. As specific examples of output data, normalized text data, a tag of equipment abnormality, and a pointer to a related case ID are output. The database management unit persists the output data in an appropriate table and index area of each database. With this configuration, the system automatically organizes and integrates unstructured data and structured data increasing day by day without human intervention, and constantly maintains high search performance and data consistency. As a result, the system exhibits a technical effect of reducing waste of storage capacity and accelerating a query response speed of the database. As a specific application field, the system is applicable to an automatic name identification system of a product catalog in a large-scale electronic commerce site, and an integrated search database of academic papers.

An external cooperation unit performs API cooperation with an external business system, groupware, an equipment management system, an external vendor system, an SNS, a mail system, and the like, performs, for example, automatic acquisition of organization reorganization and personnel arrangement change information, cooperation of a contract history with an external vendor, data cooperation with the equipment management system, import of an external FAQ and a knowledge base, a person in charge search on the SNS, notification distribution by mail, and the like, and generative AI automatically executes summarization, classification, tagging, and association of external data to achieve integration with an internal database. Specifically, the external cooperation unit establishes communication with an external server via a network interface. The external cooperation unit exchanges an authentication token using a secure communication protocol. The external cooperation unit periodically transmits a data acquisition request to an external system. The external cooperation unit receives text data in a JSON format as a response. The external cooperation unit inputs this text data into a syntax analysis module. The syntax analysis module removes unnecessary metadata and extracts pure text contents. The system inputs this extracted text data into a large language model. The large language model is a deep learning model adopting a transformer architecture. Input data is a sequence of word embedding vectors of several thousand dimensions. The large language model calculates a context dependency in a text using a self-attention mechanism. The large language model generates a summary sentence of an input text. Furthermore, the large language model outputs a probability distribution of a classification category based on contents of the text. Output data is an array of floating-point numbers indicating a probability of belonging to each category. The system adopts a category having the maximum probability as a classification label of the text. The large language model extracts an important keyword from the text, and outputs it as a character string list of tags. The system associates these summary sentence, classification label, and tag with original text data. The system stores this associated dataset in a predetermined table of the internal database. The system registers the extracted tag as a search index of the database. Thereby, the system dramatically improves a speed of search processing for a huge amount of external data. The system completely automates data classification and tagging work manually performed by a human. Thereby, the system improves accuracy of data management and eliminates a human error. The system is applied to a use case such as integrated management of an equipment maintenance history in a logistics center and automatic import of the latest delivery schedule from an external vendor.

As described above, the system according to the present embodiment includes an issue input unit, an information complementation unit, a case search unit, a solution presentation unit, an execution support unit, an effect measurement unit, a continuous improvement unit, a user interface unit, a database management unit, and an external cooperation unit, and becomes a logistics center business optimization system in which each unit executes advanced processing one by one utilizing generative AI, and realizes overall optimization and continuous business innovation involving from an on-site worker to a manager and a management layer. Specifically, the system deploys these plurality of processing modules as independent containers on a virtualization environment. The system adopts a microservice architecture. The system asynchronously transmits and receives data between the respective modules via a message queuing system. The system dynamically allocates a dedicated calculation resource to each module. The system automatically scales the number of containers according to an increase or decrease in traffic. The system calls an inference engine of a large language model in each processing step. The inference engine executes a high-speed matrix operation utilizing a parallel calculation capability of a graphics processing unit. The system maps input natural language data to a high-dimensional vector space. The system derives an optimal business process based on a distance calculation and a probability calculation on this vector space. The system eliminates a conventional business improvement method depending on human intuition and experience. The system generates an objective solution based on a pure mathematical algorithm and a statistical probability. The system aggregates log data generated by each module into a central data lake. The system periodically fine-tunes a weight parameter of the large language model using this log data. The system updates the parameter so as to minimize a value of a loss function using a backpropagation method. Thereby, the system realizes a self-evolving mechanism in which accuracy of inference improves as an operation period becomes longer. The system exhibits a powerful technical effect in a specific use case such as optimization of personnel arrangement, efficiency improvement of inventory management, and maximization of an equipment operation rate in a logistics center.

### Implementation Steps

Step 1: Issue Input/On-site Information Collection An on-site worker or a manager inputs a business issue faced in a logistics center in a natural language using a user interface of a terminal. An input method is diverse, such as text input, voice input, chatbot dialogue, image attachment, and video attachment, and a real issue on site can be input as it is, such as “often mistakenly taking a product on the same shelf in picking work”, “a scheduled arrival and an actual quantity do not match in nighttime cargo receipt”, “an operation rate of a forklift is decreasing”, “a barcode cannot be read”, and “there are many mistakes in packing work”. Specifically, the issue input unit receives text data via a touch panel display of a mobile terminal. The issue input unit converts voice waveform data acquired from a microphone of the terminal into a digital signal. The issue input unit inputs this digital signal into a voice recognition model. The voice recognition model converts an acoustic feature amount into a text character string using a recurrent neural network. The issue input unit stores RGB image data acquired from a camera of the terminal in a memory as a multidimensional tensor. The issue input unit inputs this image tensor into a convolutional neural network. The convolutional neural network detects an object or an abnormal part in an image, and outputs a feature vector. When receiving video data, the issue input unit divides a video into a plurality of frame images. The issue input unit extracts a time-series feature amount from each frame image. The system integrates input text, text derived from voice, and a feature vector derived from an image. The system combines these multimodal data into one integrated feature vector. The system transmits this integrated feature vector to a subsequent analysis module. Thereby, the system can capture a complex situation on site as digital data without omission. The system saves time and effort for a human to manually explain a situation, and dramatically improves operability of an input interface. The system is applied to a use case such as a report of a sudden equipment failure in a logistics center and a real-time error report during picking work.

Step 2: Information Complementation/Issue Clarification (Generative AI Utilization) When issue input contents are ambiguous or information is missing, generative AI automatically generates an additional question, and interactively collects supplementary information on a terminal. For example, a question such as “on which shelf are there many mistakes?”, “what is an occurrence frequency of mistakes?”, “can a situation on site be transmitted by an image or a video?”, and “what is a countermeasure when a similar mistake occurred in the past?” is automatically generated. A specific example of a prompt sentence includes “generate an additional question necessary for clarifying details and a background of an issue, a related business process, an occurrence frequency, involved equipment, an on-site situation image, a video, and the like based on input issue contents”. Specifically, the information complementation unit inputs the integrated feature vector generated in the preceding stage into a large language model. The large language model has a transformer architecture composed of an encoder and a decoder. Input data is a sequence of token embedding vectors of 512 dimensions. The large language model compares the input data with a pre-trained knowledge base. The large language model holds a list of essential information categories necessary for issue resolution. The large language model specifies an information category missing in the input data. The large language model generates a question sentence for complementing missing information. Output data is a vector indicating a probability distribution of a word to be generated next. The information complementation unit constructs the most natural question text based on this probability distribution. The system displays the generated question text on a display of the terminal. The system receives an answer text from a user. The system vectorizes this answer text again, and combines it with the original integrated feature vector. The system iteratively executes this dialogue process until all essential information is prepared. Thereby, the system proactively prevents an error in subsequent processing due to incomplete input data. The system provides a technical improvement in which a computer actively detects and complements an input omission of information by a human. The system exhibits a high effect in a use case of converting an ambiguous trouble report in a logistics center into accurate incident data.

Step 3: Issue Analysis/Keyword Extraction (Generative AI Utilization) On a server side, generative AI receives issue input contents and supplementary information, extracts a keyword such as “picking”, “mistake”, “shelf”, “nighttime”, “cargo receipt”, “forklift”, “barcode”, “packing”, and “flow line” using a natural language processing technology and an image/video analysis technology, and analyzes a gist and a background of an issue and an on-site situation from multiple angles. A specific example of a prompt sentence includes “extract a main business keyword, a related department/equipment/product category, an occurrence time, and a background factor from given issue contents and supplementary information”. Specifically, the server inputs complemented complete text data into a natural language processing model. The natural language processing model is a multi-layer neural network equipped with a self-attention mechanism. Input data is a token ID array of words obtained by dividing a text. The natural language processing model calculates a dependency between respective tokens, and generates an attention score matrix. The natural language processing model specifies a word having high importance in a context based on this attention score. Output data is a character string list of extracted keywords and a normalized score value from 0 to 1 indicating importance of each keyword. The system filters only a keyword whose importance score exceeds a predetermined threshold. The system formats the extracted keyword group as a search query of a database. The system extracts an object recognition label from image data using an image analysis technology. The system adds this object recognition label to a keyword list. Thereby, the system eliminates an unnecessary word serving as noise, and improves accuracy and speed of search processing. The system executes not simple character string matching but advanced information extraction based on a contextual meaning. The system is applied to a use case of automatically extracting a potential risk factor from a daily business report in a logistics center.

Step 4: Case database search (utilizing generative AI) A case database dedicated to the logistics center is searched based on the keyword extracted by the generative AI and the attribute information of the worker or the manager (shift, assigned area, years of experience, assigned equipment, etc.). For example, it is possible to search for a case according to an on-site situation, such as “when a day-shift worker complains of a picking mistake, a case in which a similar issue was resolved in a day-shift zone in the past is preferentially presented” or “for a barcode reading failure, a barcode print quality improvement case or a reader device replacement case is presented”. As a specific example of a prompt sentence, “extract a past case with the highest relevance from the logistics center case database based on the given issue contents and worker attribute information, and list them in descending order of similarity” can be cited. Specifically, the case search unit combines the extracted keyword group and the attribute data of the worker to construct a multidimensional search query vector. The case search unit inputs this query vector into a vector embedding model. The vector embedding model converts text data into a 768-dimensional dense vector. The case search unit accesses the case database. The case database stores past case data vectorized in advance. The case search unit calculates a cosine similarity between the query vector and each case vector in the database. The case search unit uses an approximate nearest neighbor search algorithm for this similarity calculation. The algorithm uses a hierarchical navigable small world graph structure to reduce a calculation amount. Output data is a list of pairs of a similarity score and a unique identifier of the past case. The system sorts this list in descending order of the similarity score. The system extracts detailed text data and image data of the case from a relational database using the higher-ranked identifier. Thereby, the system specifies an optimal case in milliseconds from millions of pieces of case data. The system overcomes a limitation of an exact match search in a conventional relational database, and realizes a flexible search based on semantic similarity. The system is extremely effective in a use case of instantly presenting a past response history of a skilled worker to an unknown trouble faced by a new worker.

Step 5: Automatic generation and presentation of solution and implementation procedure (utilizing generative AI) A specific solution and an implementation procedure according to an on-site situation are automatically generated based on contents of the past case extracted by the generative AI. For example, practical and detailed advice such as “color-coding of shelf labels”, “introduction of a barcode verification system”, “re-education for workers”, “digitization of a picking list”, and “revision of a packing procedure manual” is presented, and contact information of a person in charge or a related department is also guided as necessary. As a specific example of a prompt sentence, “comprehensively generate an optimal solution, its implementation procedure, notes, reference materials, and contact information based on the contents of the extracted past case and the current on-site situation” can be cited. Specifically, the solution presentation unit combines the text data of the extracted past case and the current issue data. The solution presentation unit inserts this combined data into a prompt template to generate an input character string. The solution presentation unit inputs this input character string into a generative neural network. The generative neural network is a large language model having tens of billions of parameters. Input data is an index array of tokenized text. The generative neural network analyzes a context of the past case and infers a procedure applicable to the current situation. Output data is text in a structured JSON format including a step of the solution, a necessary resource, and contact information. The system parses this JSON data. The system maps an analysis result to each display area on a user interface. The system converts the generated procedure manual into an HTML format and renders it on a screen of a terminal. Thereby, the system automatically reconstructs past knowledge in a form adapted to the current situation. The system completely eliminates time for a human to read and understand a past document and think about a procedure, and minimizes business downtime. The system is applied to a use case such as creation of an introduction procedure of new equipment in the logistics center or immediate generation of a response manual for an irregular shipping request.

Step 6: Task breakdown, execution support, and progress management (utilizing generative AI) A task necessary for executing the solution presented by the generative AI is automatically broken down and generated, and the task is registered in API cooperation with a task management tool. For example, a plurality of tasks such as “implementation of shelf label color-coding work”, “installation of a barcode verification system”, “holding of an operation briefing session for workers”, and “recording of the number of mistake occurrences for effect measurement” are automatically generated in chronological order, and when progress is delayed or a task delay occurs, a reminder notification or additional advice is automatically generated. As a specific example of a prompt sentence, “break down a task necessary for executing the presented solution, and generate contents, a person in charge, a deadline, a progress management method, and reminder notification contents of each task” can be cited. Specifically, the execution support unit inputs the generated solution text into a natural language understanding module. The natural language understanding module extracts a pair of an action verb and an object from the text. The execution support unit inputs this extraction result into a task extraction model. The task extraction model uses a conditional random field algorithm that performs sequence labeling. Input data is a sequence of word vectors. Output data is a sequence of labels indicating whether each word is a component of the task. The execution support unit extracts an individual task item, a person in charge, and a deadline based on this label. The execution support unit analyzes a dependency relationship between the extracted tasks and generates a data structure of a directed acyclic graph. The system calculates a critical path of each task based on this graph data. The system registers the calculated schedule data as a record in a task management database. The system periodically compares a system clock with the deadline of each task. When detecting a delay, the system automatically generates an alert signal. Using this alert signal as a trigger, the system transmits a push notification to a terminal of the person in charge. Thereby, the system completely automates complex project management and dramatically reduces a burden on the manager. The system exhibits a powerful technical effect in a use case such as a layout change project of the logistics center or progress management of large-scale inventory work.

Step 7: Effect measurement and feedback collection (utilizing generative AI) An execution result of the task and feedback from the worker or the manager are collected, and the generative AI measures a quantitative and qualitative effect. For example, an effect index such as “picking mistakes decreased from an average of 10 to 3 per month”, “inventory accuracy improved from 95% to 99%”, or “worker satisfaction improved” is automatically aggregated, and an improvement point is extracted from on-site voices. As a specific example of a prompt sentence, “extract a quantitative effect index and a qualitative improvement point based on the task execution result and the worker feedback, and generate an effect measurement report” can be cited. Specifically, the effect measurement unit acquires a completion status of the task and related numerical data from a business system. The effect measurement unit acquires feedback text input from a terminal by the worker. The effect measurement unit inputs this feedback text into a sentiment analysis model. The sentiment analysis model is a classifier based on deep learning. Input data is a feature vector of the text. Output data is a three-dimensional vector indicating a probability of belonging to each class of positive, negative, and neutral. The system calculates a qualitative evaluation score based on this probability vector. The system calculates a difference in a performance index before and after improvement using the acquired numerical data. The system integrates this quantitative difference data and the qualitative evaluation score. The system inputs this integrated data into a natural language generation model. The natural language generation model generates text of a human-readable effect measurement report from the integrated data. The system outputs this report text as a file in a PDF format. Thereby, the system automates advanced analysis integrating subjective opinions and objective numerical values. The system significantly reduces calculation resources and time required for data aggregation work. The system is applied to a use case such as ROI calculation after introducing a new system in the logistics center or effect verification of a work environment improvement measure.

Step 8: Continuous improvement and cross-organizational analysis (utilizing generative AI) The generative AI analyzes an issue resolution status of all sites, a past case, and feedback information obtained by the effect measurement unit chronologically and by attribute, extracts a tendency and a potential risk of the entire logistics center, detects, for example, “a tendency of frequent picking mistakes in a day-shift zone”, “a tendency of increasing inventory excess or deficiency in a night-shift zone”, or “a tendency of specific equipment troubles concentrating in a specific area”, and automatically generates a business improvement proposal or a risk preventive measure for a management layer or a management department. As a specific example of a prompt sentence, “analyze the issue resolution status and the feedback of all sites chronologically and by attribute, extract a tendency, a recurrence risk, a preventive measure, and a business improvement proposal of the entire logistics center, and generate a report for the management layer” can be cited. Specifically, the continuous improvement unit inputs accumulated effect measurement data and system log data into a time series analysis model. The time series analysis model adopts a long short-term memory network architecture. Input data is a multidimensional time series tensor including the number of incident occurrences and work time in the past few months. The time series analysis model sequentially processes sequence data while updating a hidden state vector. The time series analysis model learns periodicity and a trend in the data. Output data is an array of prediction scores indicating an incident occurrence probability in a specific time zone or area in the future. When this prediction score exceeds a preset safety threshold, the system sets a risk warning flag on a memory. The system inputs this flag and related attribute data into an anomaly detection algorithm. The anomaly detection algorithm specifies an outlier of the data using an isolation forest. The system extracts a variable causing this outlier. The system inputs this extraction result into a language generation model, and generates improvement proposal text including a specific preventive measure. Thereby, the system automatically visualizes a hidden correlation between multidimensional data that is difficult for a human to notice. The system realizes a paradigm shift from reactive management to predictive and preventive management. The system is applied to a use case supporting advanced management decisions such as formulation of a capital investment plan for the entire logistics center and strategic optimization of personnel allocation.

### Specific Use Case

For example, in the logistics center, when an issue occurs in which an on-site worker in a day-shift zone frequently mistakes products on the same shelf during picking work, the worker inputs “I often mistakenly take a product on the same shelf in picking work” in a natural language using the issue input unit of the terminal. An information complementing unit automatically generates an additional question such as “on which shelf number are there many mistakes?”, “are contents of the mistake a product number mistake or a quantity mistake?”, “what are a work environment and a time zone when the mistake occurs?”, or “can you send a photograph of a shelf label or a product arrangement on site?” using the generative AI, and the worker inputs detailed information while attaching an on-site photograph. As a specific example of a prompt sentence, “generate an additional question such as an occurrence shelf number, a type of mistake, an occurrence frequency, a work environment, and an on-site image based on the input picking mistake issue contents” can be cited. Specifically, the issue input unit temporarily saves the natural language text input by the worker as a character code string in a buffer area of a memory. The information complementing unit inputs this character code string into a morphological analysis engine. The morphological analysis engine divides the text into morphemes, which are minimum semantic units, and assigns a part-of-speech tag to each morpheme. The information complementing unit counts an appearance frequency of a noun or a verb, and generates a feature vector. The information complementing unit inputs this feature vector into a pre-trained language model. The language model collates the input vector with an internal knowledge graph. The language model specifies a parameter group indispensable for resolving a picking error. Output data is an identifier of a missing parameter and a text character string of a question sentence corresponding thereto. The system displays this question sentence as a pop-up window on a graphical user interface of the terminal. The system receives image data of the site photographed by the worker with a camera in a JPEG format. The system converts this image data into a matrix of pixel values and inputs it into an image recognition model. The image recognition model analyzes a barcode of the shelf or an arrangement state of the product, and extracts it as text data. Thereby, the system accurately grasps the on-site situation from both aspects of text and image. The system provides a technical improvement of efficiently collecting structured data processable by a computer through an interactive interface. The system is applied to a data collection process for improving accuracy of picking work or deriving a physical improvement measure for a work environment.

The case search unit extracts a keyword such as “picking”, “mistake”, “shelf”, “day shift”, or “product number mistake” and worker attribute information using the generative AI, and searches the case database. For example, a plurality of past cases according to the on-site situation are extracted, such as “a case in which picking mistakes were reduced by color-coding shelf labels and introducing a barcode verification system in a day-shift zone”, “a case in which product number mistakes were prevented by digitizing a picking list”, “a case in which a mistake occurrence rate was reduced by a worker re-education program”, or “a case in which work efficiency and accuracy were improved by reviewing a shelf arrangement”. As a specific example of a prompt sentence, “extract a past case with the highest relevance from the logistics center case database based on the given picking mistake issue contents and worker attribute information, and list them in descending order of similarity” can be cited. Specifically, the case search unit combines the extracted keyword group and the attribute data of the worker to generate one query character string. The case search unit inputs this query character string into a word embedding model. The word embedding model converts each word into a vector in a high-dimensional space, averages them, and generates a 768-dimensional query vector. The case search unit inputs this query vector into an approximate nearest neighbor search algorithm. The algorithm executes a high-speed spatial search on millions of pieces of vector data in the case database. Input data is a 768-dimensional floating-point array. The algorithm specifies a vector group having the closest Euclidean distance to the query vector. Output data is a list of pairs of a distance score and a unique identifier of the past case. The system issues an SQL query to a relational database using this identifier. The system extracts detailed text data, an attached image, and numerical data of effect measurement of the corresponding case. Thereby, the system realizes an advanced search based on similarity of context or meaning without depending on a simple keyword match. The system exhibits a technical effect of dramatically reducing a calculation load due to an exhaustive search and shortening a search response time to milliseconds. The system is extremely effective in a use case of rapidly applying a past success case to a current similar trouble and accelerating a problem-solving cycle.

The solution presentation unit automatically generates a specific solution and an implementation procedure according to the on-site situation using the generative AI based on the contents of the extracted past case. For example, practical and detailed advice is presented, such as “picking mistakes can be reduced by color-coding shelf labels and introducing a barcode verification system”, “product number mistakes can be prevented by digitizing a picking list and creating a list with product images”, “a mistake occurrence rate can be reduced by implementing a worker re-education program and thoroughly enforcing standardization of a picking procedure and notes”, or “mix-ups can be prevented by reviewing a shelf arrangement and arranging similar products apart”, and contact information or reference information such as “a person in charge of this case is Sato of the logistics management department”, “a related department is the information system department”, or “refer to the knowledge base for details of a past shelf label color-coding case” is also guided as necessary. As a specific example of a prompt sentence, “comprehensively generate an optimal solution, its implementation procedure, notes, reference materials, and contact information based on the contents of the extracted picking mistake case and the current on-site situation” can be cited. Specifically, the solution presentation unit inserts the extracted past case data and the current on-site situation data into a predetermined variable area of a prompt template. The solution presentation unit inputs this constructed prompt into a large language model. The large language model has a structure in which a plurality of decoder blocks of a transformer architecture are stacked. Input data is an index array of tokenized text. The large language model calculates relevance between a step of a past solution and a constraint condition of a current issue using a self-attention mechanism. The large language model generates text of a new procedure optimized for the current situation. Output data is text in a structured JSON format including a title of the solution, an itemized list of specific steps, a necessary resource, and contact information of a related department. The system parses this JSON data and extracts each element. The system pours the extracted elements into an HTML template, and dynamically generates screen data of a highly visible business instruction manual. The system transmits this screen data to the terminal and displays it. Thereby, the system dynamically reconstructs a past static document according to a current context. The system completely eliminates a cognitive load for a human to assemble a procedure by referring to a plurality of materials. The system is applied to a use case such as immediate correction of a picking mistake in the logistics center or rapid on-site deployment of a new work procedure.

The execution support unit automatically breaks down and generates a task necessary for executing the presented solution using the generative AI, automatically generates a plurality of tasks such as “implementation of shelf label color-coding work”, “installation of a barcode verification system”, “holding of an operation briefing session for workers”, and “recording of the number of mistake occurrences for effect measurement” in cooperation with a task management tool, and manages a progress status. When progress is delayed, a reminder notification or additional advice such as “shelf label color-coding work is delayed. Allocation of an additional worker is proposed” or “progress of barcode verification system installation is unstarted. Do you want to send a reminder to a person in charge?” is automatically generated. As a specific example of a prompt sentence, “break down a task necessary for executing the presented picking mistake solution, and generate contents, a person in charge, a deadline, a progress management method, and reminder notification contents of each task” can be cited. Specifically, the execution support unit inputs the generated solution text into a natural language understanding module. The natural language understanding module generates a syntax analysis tree, and extracts a pair of an action verb and an object from the text. The execution support unit inputs this extraction result into a task generation model. The task generation model is a neural network that performs sequence-to-sequence conversion. Input data is a word vector sequence of the solution text. Output data is a data structure of a directed acyclic graph indicating a task name, an estimated required time, and a dependency relationship between tasks. The system calculates a critical path of the entire project based on this graph data. The system calculates an estimated start time and an estimated end time of each task, and registers them in a scheduler database. The system periodically polls a status flag of each task. The system detects a node whose current time exceeds the estimated end time and whose status flag is incomplete. Using this delay detection as a trigger, the system requests a language generation model to generate an alert message. The system transmits the generated message to a terminal of the person in charge as a push notification. The system automatically recalculates and updates a schedule of a subsequent task depending on the delayed task. Thereby, the system completely automates dynamic project management and prevents a schedule breakdown. The system exhibits a powerful technical effect in a use case such as progress management of an equipment introduction project in the logistics center or execution support of a business improvement measure in which a plurality of departments cooperate.

The effect measurement unit collects an execution result of the task and feedback from a worker or a manager, automatically aggregates quantitative effect indicators such as “picking mistakes decreased from an average of 10 to 3 per month”, “work efficiency improved by 15%”, and “worker satisfaction improved” using the generative AI, and also extracts qualitative feedback such as “there was an unclear point in an operation method of a new system” and “there was a backlash from the worker” by text mining or sentiment analysis. A specific example of a prompt sentence includes “extract a quantitative effect indicator and a qualitative improvement point of a picking mistake solution based on a task execution result and worker feedback, and generate an effect measurement report”. Specifically, the effect measurement unit extracts numerical data of a picking error rate and a work time from a business database using an SQL query. The effect measurement unit inputs a feedback text input by the worker to a text mining engine. The text mining engine performs morphological analysis and syntactic analysis, and extracts frequently appearing noun phrases and adjective phrases. The effect measurement unit inputs this text data to a sentiment analysis model. The sentiment analysis model is a support vector machine or a deep learning model. Input data is a TF-IDF feature vector of the text. Output data is a three-dimensional vector indicating classification probabilities of positive, negative, and neutral. The system automatically classifies the feedback into categories such as “system operation”, “work environment”, and “human relations” based on this probability vector. The system cross-tabulates qualitative data of a classification result and the extracted quantitative data. The system generates a multidimensional analysis cube from this aggregation result. The system inputs data of this analysis cube to a natural language generation model, and generates a text of a summary report. Thereby, the system integrates a huge amount of unstructured data and structured data, and automatically calculates an objective evaluation indicator. The system completely eliminates time for manual data aggregation and report creation by a human. The system is applied to use cases such as verification of an introduction effect of a new picking system in a logistics center and measurement of a retention degree of a worker education program.

The continuous improvement unit analyzes the issue resolution status of all sites and the feedback obtained by the effect measurement unit chronologically and by attribute using the generative AI, extracts “a tendency that picking mistakes frequently occur in a day shift zone”, “a tendency that mistakes concentrate on a specific shelf”, and the like, automatically generates a business improvement proposal and a risk preventive measure such as “company-wide deployment of shelf label color coding” and “standardization of picking list digitization”, and reports to the management layer or the management department. A specific example of a prompt sentence includes “analyze a picking mistake issue resolution status and feedback of all sites chronologically and by attribute, extract a tendency of an entire logistics center, a recurrence risk, a proactive preventive measure, and a business improvement proposal, and generate a report for a management layer”. Specifically, the continuous improvement unit inputs the data of the generated analysis cube to an anomaly detection algorithm. The anomaly detection algorithm is a deep learning model using an autoencoder. Input data is a multidimensional vector including the number of picking mistakes of each shelf, a work time, and an attribute of a worker. The autoencoder compresses the input data into a low-dimensional latent space, and restores it to an original dimension again. The system calculates a reconstruction error between the input data and restored data. Output data is an anomaly score of each data point based on this reconstruction error. When this anomaly score indicates a statistical outlier, the system extracts a combination of attributes causing the outlier. The system inputs this extraction result to a language generation model. The language generation model generates a text of a company-wide business improvement proposal based on the extracted factor. The system displays this proposal text on a dashboard screen, and requests approval of an administrator. The system feeds back the approved proposal to the execution support unit as a new task. Thereby, the system autonomously promotes process improvement of the entire organization without being limited to local issue resolution. The system provides a technical improvement that mathematically elucidates a complex correlation between multivariate data that is difficult for a human to notice. The system is extremely effective in advanced use cases such as revision of a company-wide standard operating procedure of the logistics center and formulation of a medium-to-long-term capital investment plan.

In this way, the system of the present invention automates from issue clarification, search for an optimal past case, presentation of a specific solution, task management and progress support, effect measurement, to cross-organizational analysis and improvement proposal consistently using the generative AI starting from a real issue on site, and realizes total optimization and continuous business innovation involving from an on-site worker to a manager and a management layer. Specifically, the system includes a main orchestrator that integrally controls each of the above-described processing modules. The main orchestrator constantly monitors a data flow between the modules. When detecting a processing bottleneck, the main orchestrator dynamically reallocates a computing resource. The system extracts a high-dimensional feature amount from input natural language data, and derives an optimal solution through a complex matrix operation on a vector space. The system autonomously executes not only mere presentation of information but also automatic generation of a task, real-time monitoring of progress, and retraining of a machine learning model based on feedback. The system accumulates log data obtained in each step as training data. The system periodically fine-tunes a weight parameter of a large language model using this training data. The system minimizes a loss function using a backpropagation method. Thereby, the system realizes a self-evolving architecture in which inference accuracy continuously improves by continuing operation. The system processes a huge amount of data at a speed and accuracy exceeding a limit of human cognitive ability. The system fundamentally solves extremely important technical issues of resolving a chronic labor shortage, equalizing work quality, and optimally allocating management resources in a logistics industry.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

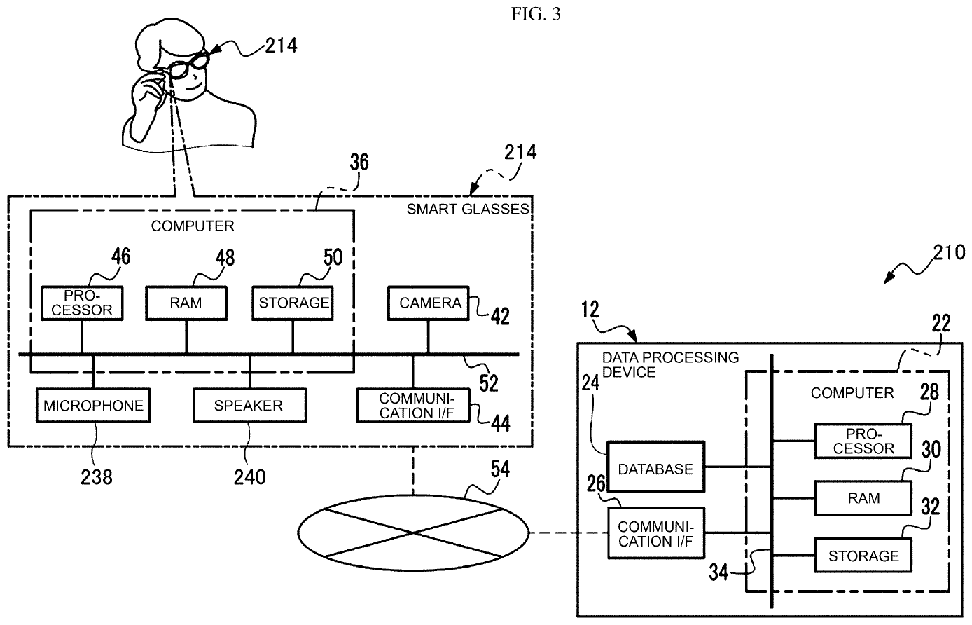

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

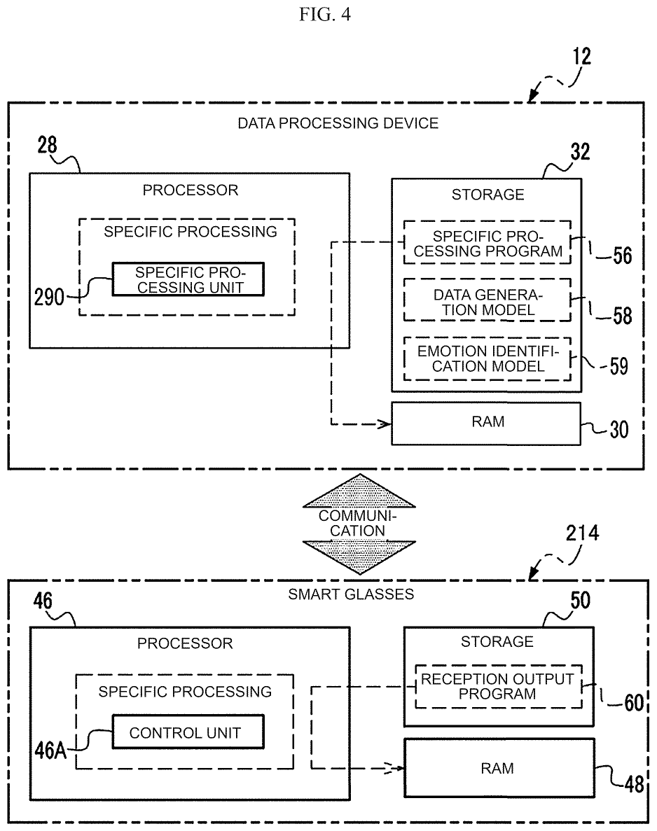

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

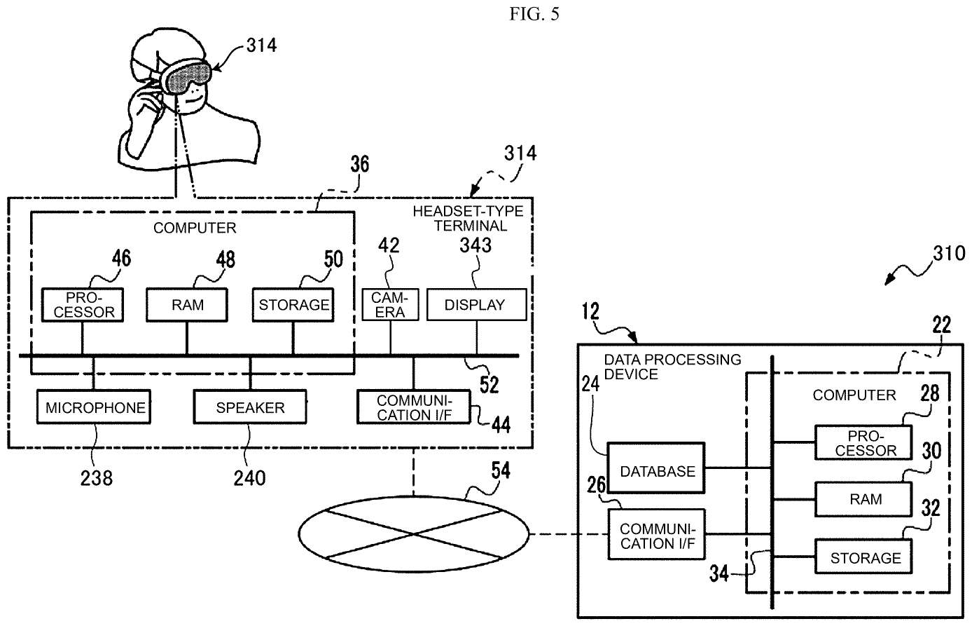

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

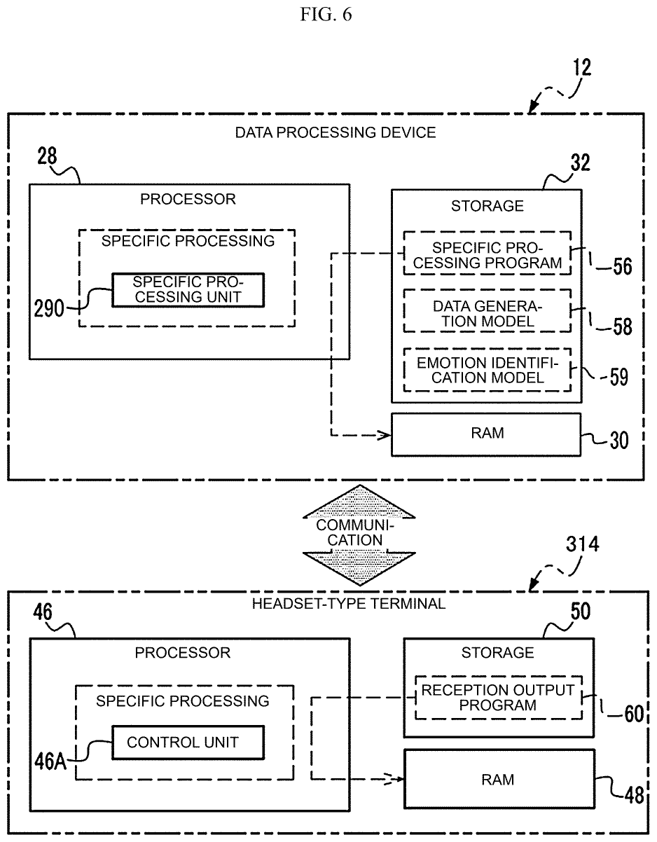

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

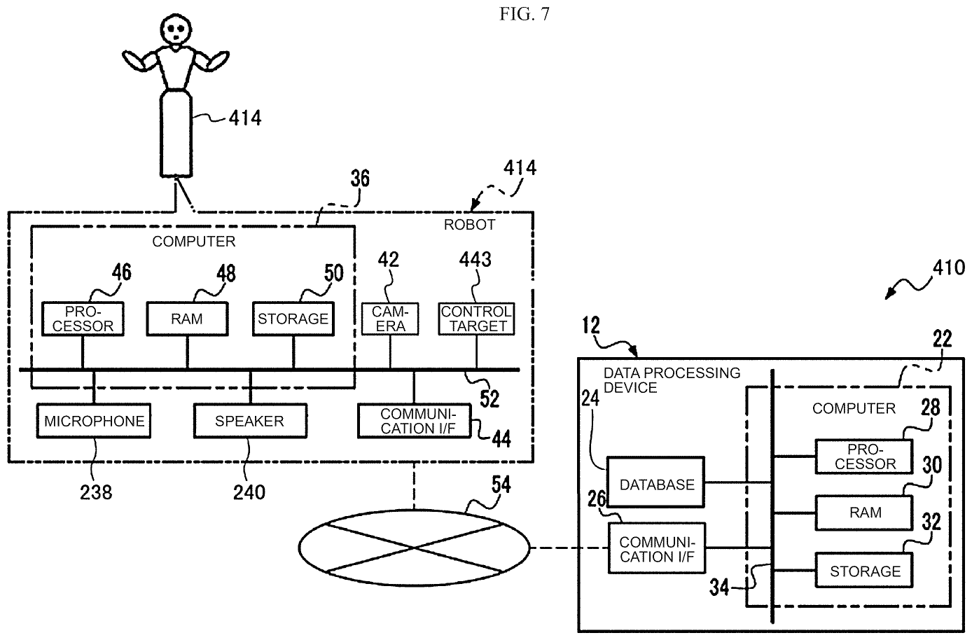

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

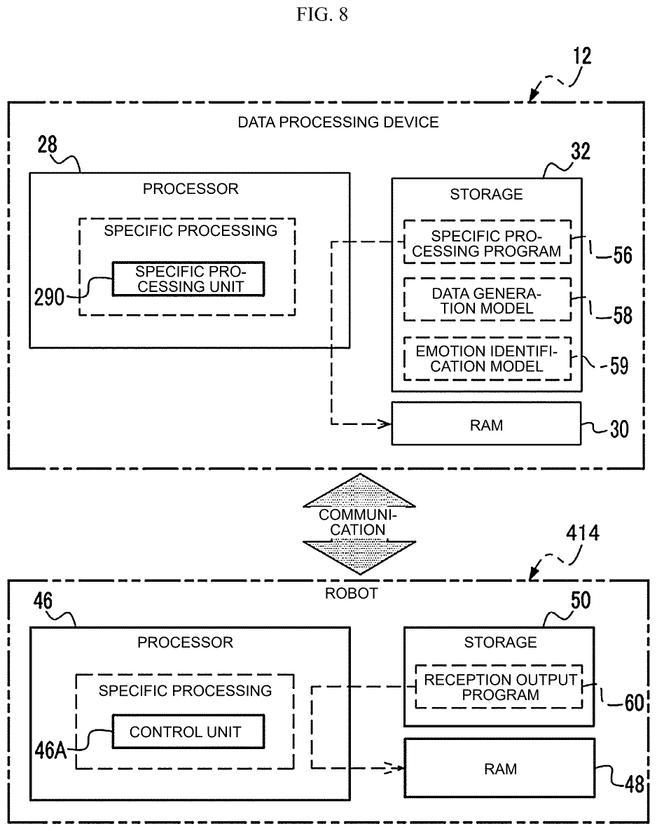

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

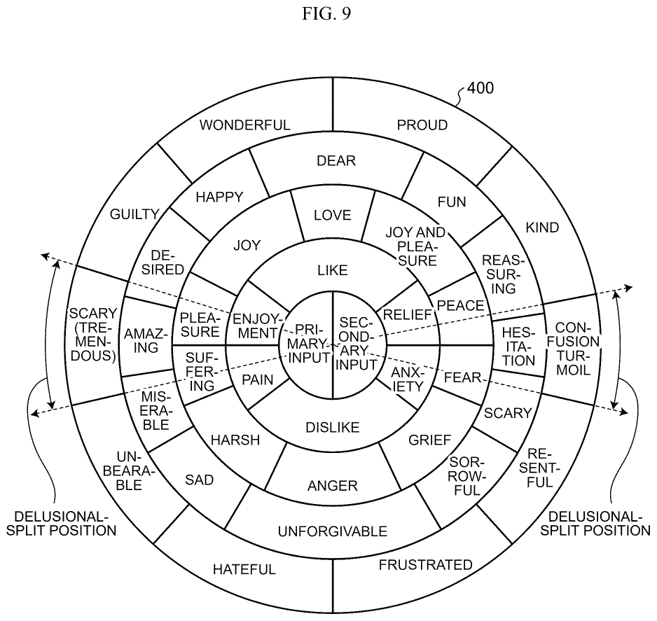

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

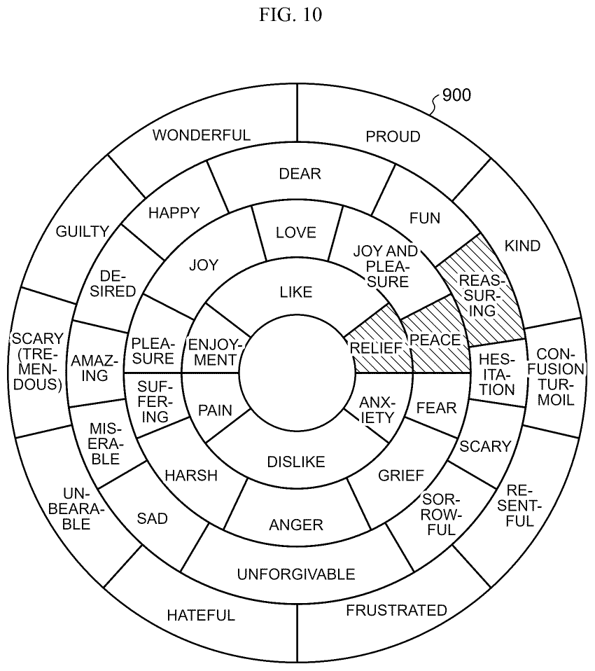

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### Supplementary Note 1

A logistics center business optimization system comprising: an issue input unit; a case search unit; a solution presentation unit; an execution support unit; an effect measurement unit; and a continuous improvement unit, wherein the issue input unit has a function of receiving a business issue in a natural language from an on-site worker or a manager of a logistics center, and has a function of, when input contents are ambiguous or information is missing, automatically generating an additional question using generative AI and interactively complementing the information; the case search unit has a function of extracting a keyword and attribute information of the on-site worker or the manager from the issue input contents using the generative AI, searching a case database dedicated to the logistics center, and extracting a past similar case; the solution presentation unit has a function of automatically generating and presenting a specific solution and an implementation procedure according to an on-site situation, necessary equipment and systems, notes, reference materials, and contact information of a person in charge or a related department using the generative AI based on contents of the extracted past case; the execution support unit has a function of automatically breaking down and generating a task necessary for executing the presented solution using the generative AI, registering the task in cooperation with a task management tool, and performing progress management and reminder notification; the effect measurement unit has a function of collecting an execution result of the task and feedback from the site, and automatically aggregating and analyzing a quantitative and qualitative effect using the generative AI; and the continuous improvement unit has a function of analyzing an issue resolution status of all sites and feedback information obtained by the effect measurement unit chronologically and by attribute by the generative AI, extracting a tendency and a potential risk of an entire organization, automatically generating an improvement proposal and a risk preventive measure, and reporting to a management department or a management layer, wherein all of these units operate using the generative AI.

### Supplementary Note 2

The logistics center business optimization system according to Supplementary Note 1, wherein the issue input unit has a function of automatically detecting ambiguity or missing information of issue contents using the generative AI for the business issue input from the on-site worker or the manager, and interactively guiding an additional question or an input of supplementary information necessary for specifying the issue or grasping a background.

### Supplementary Note 3

The logistics center business optimization system according to Supplementary Note 1, wherein the continuous improvement unit has a function of analyzing the issue resolution status of all sites, the past case, and the on-site feedback collected by the effect measurement unit chronologically, by attribute, and from multiple angles using the generative AI, automatically extracting an issue frequently occurring in the logistics center, an event with a high recurrence risk, a tendency of equipment trouble, a factor of work efficiency deterioration, a problem in safety management, and the like, and periodically notifying the management department or the management layer of a preventive measure or an improvement proposal using the generative AI.

What is claimed is:

1. A system comprising:
circuitry configured to:
receive, via a communication interface coupled to a packet-switched network, issue description data from a terminal device, and store the issue description data in a storage device;
apply a lightweight convolutional neural network model on the terminal device to perform initial feature extraction from the issue description data, and transmit a compact feature vector to a cloud computing node via the communication interface;
apply a large-scale language model on the cloud computing node to the compact feature vector and a query embedding vector derived from the issue description data to retrieve candidate case records from a case database by cosine similarity search, and rank the retrieved candidate case records by a relevance score;
apply the large-scale language model to the ranked candidate case records and the issue description data to generate a solution proposal data record comprising a step-by-step resolution sequence, a contact routing data record, and a task list; and
transmit the solution proposal data record to the terminal device via the communication interface.

2. The system according to claim 1, wherein the circuitry is configured to receive audio waveform data from the terminal device via the communication interface, apply a speech recognition model to convert the audio waveform data to text, apply barcode scan data from a barcode reader device to extract equipment identifier data, and incorporate the converted text and equipment identifier data into the issue description data.

3. The system according to claim 2, wherein the circuitry is configured to receive image data from a camera device at the terminal device via the communication interface, apply a convolutional neural network to the image data to generate an image feature vector, and incorporate the image feature vector as an additional input dimension in the compact feature vector transmitted to the cloud computing node.

4. The system according to claim 1, wherein the circuitry is configured to extract keywords from the issue description data using a keyword extraction model, generate a keyword embedding vector from the extracted keywords, compute cosine similarity scores between the keyword embedding vector and case record embedding vectors stored in a vector database, and select candidate case records having similarity scores exceeding a retrieval threshold.

5. The system according to claim 4, wherein the circuitry is configured to incorporate employee attribute data associated with a user identifier retrieved from the storage device as weighting factors applied to cosine similarity scores during candidate case record ranking, and personalize the solution proposal data record based on the employee attribute data.

6. The system according to claim 1, wherein the circuitry is configured to generate the task list from the solution proposal data record by applying the large-scale language model to extract action item text, assignee role identifiers, and deadline parameters from the resolution sequence, format the task list as a structured data object, and transmit the task list to a task management system endpoint via the communication interface.

7. The system according to claim 6, wherein the circuitry is configured to receive task progress update records from the task management system endpoint via the communication interface, update the task list status fields in the storage device, and generate a progress notification data record for transmission to the terminal device when a task status changes.

8. The system according to claim 1, wherein the circuitry is configured to receive feedback data from the terminal device following task completion comprising effectiveness rating values and outcome description text, store the feedback data as a new case record in the case database, compute a case record embedding vector for the new case record, and index the new case record embedding vector in the vector database.

9. The system according to claim 8, wherein the circuitry is configured to apply the large-scale language model to the feedback data and the corresponding solution proposal data record to generate a measure effectiveness score, update the relevance score weighting parameters for the corresponding case record based on the measure effectiveness score, and store updated weighting parameters in the case database.

10. The system according to claim 1, wherein the circuitry is configured to apply an in-memory data grid on the cloud computing node to cache frequently retrieved case records and their embedding vectors, apply a cache eviction algorithm to replace low-access-frequency case record cache entries with high-access-frequency entries, and reduce retrieval latency for high-demand issue categories.

11. The system according to claim 1, wherein the circuitry is configured to generate the contact routing data record by applying the large-scale language model to the issue description data and an organizational contact registry to identify the most relevant organizational unit identifier and contact role identifier, and transmit the contact routing data record as a structured notification to the identified contact endpoint.

12. The system according to claim 1, wherein the circuitry is configured to aggregate issue description data records across all user identifiers over a configurable time window, apply the large-scale language model to identify recurring issue pattern clusters, generate a trend analysis report from the identified clusters, and transmit the trend analysis report to terminal devices associated with management user identifiers.

13. The system according to claim 1, wherein the circuitry is configured to apply a report generation model to the issue description data, the solution proposal data record, and task completion records retrieved from the storage device to generate a structured performance report, and transmit the performance report to designated terminal devices at configurable periodic intervals.

14. The system according to claim 1, wherein the circuitry is configured to enforce a role-based access control policy by restricting case record retrieval to records within the permission scope of the requesting user identifier, and apply data minimization processing to return only fields authorized for the requesting user role parameter.

15. The system according to claim 1, wherein the circuitry is configured to distribute incoming issue description data processing requests across a plurality of large-scale language model inference nodes via a load balancer, assign high-priority requests identified by urgency indicator values to dedicated inference nodes, and maintain response latency below a maximum latency threshold.

16. The system according to claim 1, wherein the circuitry is configured to apply radio frequency identification reader data from a terminal device at the logistics site to extract location identifier data and item identifier data, incorporate the extracted identifiers as additional contextual parameters in the issue description data, and weight case record retrieval toward records associated with matching location and item identifiers.

17. The system according to claim 1, wherein the issue description data comprises natural language text describing operational issues at a logistics processing facility, the case database stores historical issue resolution records indexed by domain category and resolution effectiveness score, and the solution proposal data record provides step-by-step resolution guidance specific to the issue description.

18. A system comprising:
circuitry configured to:
receive, via a communication interface coupled to a packet-switched network, issue description data from a terminal device, apply a lightweight convolutional neural network on the terminal device for initial feature extraction, and transmit a compact feature vector to a cloud computing node;
apply a large-scale language model to retrieve candidate case records by cosine similarity search from a vector database, rank records by relevance score, and generate a solution proposal data record comprising a resolution sequence, contact routing data, and a task list;
transmit the task list to a task management system and receive task progress updates, and collect feedback data from terminal devices upon task completion to add new records to the case database; and
transmit the solution proposal data record to the terminal device and generate trend analysis reports from aggregated issue pattern clusters.

19. The system according to claim 18, wherein the circuitry is configured to incorporate employee attribute data as weighting factors in case record ranking, apply a measure effectiveness score derived from feedback data to update relevance score weighting parameters, and apply an in-memory data grid to cache frequently retrieved case records for reduced retrieval latency.

20. A method comprising:
receiving, via a communication interface coupled to a packet-switched network, issue description data from a terminal device, and storing the issue description data in a storage device;
applying a lightweight convolutional neural network on the terminal device for initial feature extraction and transmitting a compact feature vector to a cloud computing node;
applying a large-scale language model to retrieve candidate case records by cosine similarity search and rank records by relevance score;
applying the large-scale language model to generate a solution proposal data record comprising a resolution sequence, contact routing data, and a task list; and
transmitting the solution proposal data record to the terminal device via the communication interface.
